(19) United States
(12) Patent Application Publication
(10) Pub. No.: US 2026/0129598 A1
(43) Pub. Date: May 7, 2026

(54) ACCESS BARRING DURING DISASTER ROAMING IN A COMMUNICATION NETWORK SYSTEM

(71) Applicant: Samsung Electronics Co., Ltd., Suwon-si (KR)

(72) Inventors: Jagadeesh GANDIKOTA, Bangalore (IN); Lalith KUMAR, Bangalore (IN); Danish Ehsan HASHMI, Bangalore (IN); Pratibha Kattemane SATYAGANAPATI, Bangalore (IN); Arvind RAMAMURTHY, Bangalore (IN); Anurag MANDILWAR, Bangalore (IN)

(21) Appl. No.: 19/401,873

(22) Filed: Nov. 26, 2025

Related U.S. Application Data
(63) Continuation of application No. PCT/KR2025/018004, filed on Nov. 5, 2025.

(30) Foreign Application Priority Data
Nov. 7, 2024 (IN) 202441085595
Nov. 11, 2024 (IN) 202441086705
Sep. 30, 2025 (IN) 2024 41085595

(51) Int. Cl. H04W 60/00; H04W 4/90

(52) U.S. Cl. CPC H04W 60/00; H04W 4/90

(57) ABSTRACT

A method performed by a user equipment (UE) for access barring during disaster roaming in a communication network system is provided. The method includes receiving, by the UE, an access stratum (AS) message from a network apparatus providing disaster roaming services for registered UEs, wherein the AS message comprises at least one of disaster-related information or access barring indication to be applied to inbound disaster roaming UEs, determining, by the UE, whether the UE is barred from using the disaster roaming services from the network apparatus based on the received AS message, and performing, by the UE, one of preventing, by the UE, to attempt to register or send any non-access stratum (NAS) or the AS message on the network apparatus providing the disaster roaming services for registering or sending the NAS or AS signaling message for disaster roaming services, in response to determining that the UE is barred from using the disaster roaming services from the network apparatus; or allowing, by the UE, to attempt to register or send any NAS or the AS message on the network apparatus providing the disaster roaming services for registering or sending the NAS or AS signaling message for disaster roaming services, in response to determining that the UE is not barred from using the disaster roaming services from the network apparatus.

### CROSS-REFERENCE TO RELATED APPLICATION(S)

The application is a continuation application, claiming priority under 35 U.S.C. § 365(c), of an International application No. PCT/KR2025/018004, filed on Nov. 5, 2025, which is based on and claims the benefit of an Indian Provisional patent application 202441085595, filed on Nov. 7, 2024, in the India Intellectual Property Office, of an Indian Patent Application number 202441086705, filed on Nov. 11, 2024, in the Indian Intellectual Property Office, and of an Indian Complete patent application No. 202441085595, filed on Sep. 30, 2025, in the Indian Intellectual Property Office, the disclosure of each of which is incorporated by reference herein in its entirety.

### FIELD OF INVENTION

The disclosure relates to a field of wireless communication network systems. More particularly, the disclosure related to methods and systems for implementing access barring during disaster roaming within a communication network system.

### BACKGROUND

The advent of fifth generation (5G) technology and the Evolved Packet System (EPS) has significantly enhanced the capabilities of mobile communication systems, enabling higher data rates, lower latency, and more reliable connections. Among the various features supported by these advanced systems is the Minimization of Service Interruption (MINT), which aims to ensure that user equipment (UE) can obtain service from a Public Land Mobile Network (PLMN) offering disaster roaming services when a disaster condition applies to the UE's determined PLMN.

The above information is presented as background information only to assist with an understanding of the disclosure. No determination has been made, and no assertion is made, as to whether any of the above might be applicable as prior art with regard to the disclosure.

### OBJECT OF THE INVENTION

Aspects of the disclosure are to address at least the above-mentioned problems and/or disadvantages and to provide at least the advantages described below. Accordingly, an aspect of the disclosure is to provide a method, a user equipment (UE), and a network apparatus for access barring during disaster roaming in a communication network system.

Another aspect of the disclosure is to provide a utilize broadcast information i.e. System Information Block (SIB) that carries information related to access class barring specifically for the UEs that are trying to access the network for disaster roaming services. The information about access barring of disaster roaming can be part of the existing System Information Block or a new System Information Block.

Another aspect of the disclosure is to provide a method for the UEs trying to access the network for disaster roaming services over EPS to evaluate the access class barring information broadcasted by the network and then establish the connection with the network or refrain from accessing the network.

Another aspect of the disclosure is to provide a method for the UE to read the SIB information and find out that the home PLMN or initial first PLMN or RAT is no longer part of the disaster roaming PLMN list of the serving PLMN and thus identify that the disaster condition on HPLMN or initial first PLMN or RAT has ended and optionally perform deregistration from the disaster roaming PLMN and then perform PLMN selection or cell selection or reselection and register on PLMN A.

Another aspect of the disclosure is to provide a method for the UEs registered on a disaster roaming PLMN for disaster roaming services to enter the PLMN search state and perform PLMN or RAT search and (re)selection procedures when a congestion cause code is received from the serving network PLMN in response to one of the UE messages (Service request or Tracking area Update request or Attach Request), for example, reject cause #22 Congestion.

Additional aspects will be set forth in part in the description which follows and, in part, will be apparent from the description, or may be learned by practice of the presented embodiments.

### SUMMARY

In accordance with an aspect of the disclosure, a method performed by a user equipment (UE) for access barring during disaster roaming in a communication network system is provided. The method includes receiving, by the UE, an access stratum (AS) message from a network apparatus providing disaster roaming services for registered UEs, wherein the AS message includes at least one of disaster-related information or an access barring indication to be applied to inbound disaster roaming UEs, determining, by the UE, whether the UE is barred from using the disaster roaming services from the network apparatus based on the received AS message, and performing, by the UE, one of: preventing, by the UE, to attempt to register or send any non-access stratum (NAS) or the AS message on the network apparatus providing the disaster roaming services for registering or sending the NAS or AS signaling message for disaster roaming services, in response to determining that the UE is barred from using the disaster roaming services from the network apparatus; or allowing, by the UE, to attempt to register or send any NAS or the AS message on the network apparatus providing the disaster roaming services for registering or sending the NAS or AS signaling message for disaster roaming services, in response to determining that the UE is not barred from using the disaster roaming services from the network apparatus.

In accordance with another aspect of the disclosure, a method performed by a network apparatus for access barring during disaster roaming in a communication network system is provided. The method includes creating, by the network apparatus, an access stratum (AS) message including disaster-related information and an access barring indication to be applied to inbound disaster roaming user equipment (UE), wherein the network apparatus is providing disaster roaming services to the UE, and sending, by the network apparatus, the AS message to the UE during the disaster.

In accordance with another aspect of the disclosure, the AS message including disaster-related information and access class barring indication information is either or broadcast message or a dedicated network to UE signaling message.

In accordance with another aspect of the disclosure, a method performed by a user equipment (UE) for access barring during disaster roaming in a communication network system is provided. The method includes receiving, by the UE, a system information block (SIB) information broadcasted by a network apparatus, determining, by the UE, whether a home public land mobile network (HPLMN) or an equivalent HPLMN (EHPLMN) or first initial PLMN or visited public land mobile network (VPLMN) is not part of a list of common PLMNs with disaster conditions, determining, by the UE, that a disaster condition in the HPLMN or EHPLMN or first initial PLMN or VPLMN has ended, when the HPLMN or the EHPLMN or first initial PLMN or VPLMN is not part of the list of common PLMNs with disaster conditions, and deregistering, by the UE, from a current serving network apparatus upon determining that the disaster condition has ended on the HPLMN or the EHPLMN or first initial PLMN or VPLMN.

In accordance with another aspect of the disclosure, a method performed by a user equipment (UE) for access barring during disaster roaming in a communication network system is provided. The method includes registering, by a UE, with a home public land mobile network (HPLMN) or an equivalent home PLMN (EHPLMN) or first initial PLMN or VPLMN for normal services, detecting, by the UE, a disaster condition on the HPLMN or the EHPLMN or first initial PLMN or VPLMN, registering, by the UE, with a network apparatus in response to the detected disaster condition, wherein the network apparatus is initially part of a forbidden PLMN list for the UE, receiving, by the UE, a reject message due to core network congestion with a reject cause code from the network apparatus, performing, by the UE, a PLMN search to find a third PLMN providing disaster roaming services, wherein the third PLMN is different from both the HPLMN or first initial PLMN or VPLMN and a current serving network apparatus, and registering, by the UE, with the third PLMN to maintain or access the disaster roaming services.

In accordance with another aspect of the disclosure, a user equipment (UE) for access barring during disaster roaming in a communication network system is provided. The UE includes memory, including one or more storage media, storing instructions, and one or more processors communicatively coupled to the memory, wherein the instructions, when executed by the one or more processors individually or collectively, cause the UE to receive an access stratum (AS) message from a network apparatus providing disaster roaming services for registered UEs, wherein the AS message includes at least one of disaster-related information or access barring indication to be applied to inbound disaster roaming UEs, determine whether the UE is barred from using disaster roaming services from the network apparatus based on the received AS message, and perform one of: prevent to attempt to register or send any non-access stratum (NAS) or the AS message on the network apparatus providing the disaster roaming services for registering or sending the NAS or the AS message for disaster roaming services, in response to determining that the UE is barred from using the disaster roaming services from network apparatus, or allow to attempt to register or send any NAS or the AS message on the network apparatus for registering or sending the NAS or the AS message for disaster roaming services, in response to determining that the UE is not barred from using the disaster roaming services from the network apparatus.

In accordance with another aspect of the disclosure, a network apparatus for access barring during disaster roaming in a communication network system is provided. The network apparatus includes memory, including one or more storage media, storing instructions, and one or more processors communicatively coupled to the memory, wherein the instructions, when executed by the one or more processors individually or collectively, cause the network apparatus to create an access stratum (AS) message including disaster-related information and access barring indication to be applied to inbound disaster roaming user equipment (UE), wherein the network apparatus is providing disaster roaming services to the UE, and send the AS message to the UE during the disaster.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include receiving, by the UE, an access stratum (AS) message from a network apparatus providing disaster roaming services for registered UEs, wherein the AS message comprises at least one of disaster-related information or an access barring indication to be applied to inbound disaster roaming UEs, determining, by the UE, whether the UE is barred from using the disaster roaming services from the network apparatus based on the received AS message, and performing, by the UE, one of preventing, by the UE, to attempt to register or send any non-access stratum (NAS) or the AS message on the network apparatus providing the disaster roaming services for registering or sending the NAS or AS signaling message for disaster roaming services, in response to determining that the UE is barred from using the disaster roaming services from the network apparatus, or allowing, by the UE, to attempt to register or send any NAS or the AS message on the network apparatus providing the disaster roaming services for registering or sending the NAS or AS signaling message for disaster roaming services, in response to determining that the UE is not barred from using the disaster roaming services from the network apparatus.

Other aspects, advantages, and salient features of the disclosure will become apparent to those skilled in the art from the following detailed description, which, taken in conjunction with the annexed drawings, disclosure various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1A is a schematic diagram that illustrates an existing mechanism for access barring UEs for disaster roaming connections according to the related art;

FIG. 1B is a sequence diagram that illustrates an existing mechanism for access barring UEs for disaster roaming connections according to the related art;

FIG. 2A is a schematic diagram that illustrates an existing mechanism where a UE A is unaware that the disaster condition on a PLMN A has ended according to the related art;

FIG. 2B is a sequence diagram that illustrates an existing mechanism where a UE A is unaware that the disaster condition on a PLMN A has ended according to the related art;

FIG. 3A is a schematic diagram that illustrates an existing mechanism where a UE A is unable to get services from a PLMN B due to core network (NW) congestion according to the related art;

FIG. 3B is a sequence diagram that illustrates an existing mechanism where a UE A is unable to get services from a PLMN B due to core NW congestion according to the related art;

FIG. 4A is a schematic diagram that illustrates an existing mechanism where a PLMN B has not sent a detach or deregistration request to a UE C according to the related art;

FIG. 4B is a sequence diagram that illustrates an existing mechanism where a PLMN B has not sent a detach or deregistration request to a UE C according to the related art;

FIG. 5 is a block diagram that illustrates the hardware components associated with the UE according to an embodiment of the disclosure;

FIG. 6 is a block diagram that illustrates the hardware components associated with the network apparatus according to an embodiment of the disclosure;

FIG. 7 is a flow diagram that illustrates a proposed method for access barring during disaster roaming in a communication network system by the UE according to an embodiment of the disclosure;

FIG. 8 is a flow diagram that illustrates a proposed method for access barring during disaster roaming in a communication network system by the network apparatus according to an embodiment of the disclosure;

FIG. 9 is a flow diagram that illustrates another proposed method for access barring during disaster roaming in a communication network system by the UE according to an embodiment of the disclosure;

FIG. 10 is a flow diagram that illustrates yet another proposed method for access barring during disaster roaming in a communication network system by the UE according to an embodiment of the disclosure;

FIG. 11A is a schematic diagram that illustrates the proposed mechanism where the network (NW) broadcasts the SIB with disaster roaming access bar information according to an embodiment of the disclosure;

FIG. 11B is a sequence diagram that illustrates the proposed mechanism where NW broadcasts the SIB with disaster roaming access bar information according to an embodiment of the disclosure;

FIG. 12A is a schematic diagram that illustrates a proposed mechanism where the UE identifies the disaster roaming condition end through the disaster PLMN list in SIB according to an embodiment of the disclosure;

FIG. 12B is a sequence diagram that illustrates a proposed mechanism where the UE identifies the disaster roaming condition end through the disaster PLMN list in SIB according to an embodiment of the disclosure;

FIG. 13A is a schematic diagram that illustrates a proposed mechanism where the UE performs PLMN selection and registration based on reject cause according to an embodiment of the disclosure;

FIG. 13B is a sequence diagram that illustrates a proposed mechanism where the UE performs PLMN selection and registration based on reject cause according to an embodiment of the disclosure;

FIG. 14A is a schematic diagram that illustrates the proposed mechanism of faster return to HPLMN or EHPLMN or first initial PLMN or VPLMN according to an embodiment of the disclosure; and

FIG. 14B is a sequence diagram that illustrates the proposed mechanism where the UE performs PLMN search based on disaster condition end according to an embodiment of the disclosure.

Throughout the drawings, like reference numerals will be understood to refer to like parts, components, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {‘C’, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN), Institute of Electrical and Electronics Engineers (IEEE) or the like), but it is only of an example for explanation, and the various embodiments of the disclosure may be easily modified even in other communication systems and applied thereto.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The drawings help illustrate the technical features but do not limit the embodiments. The disclosure includes any modifications, equivalents, and substitutes beyond those shown. Terms like first, second, etc., are used for distinction and do not limit the elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

In the event of a disaster, UEs can obtain service from PLMN operators prepared to offer disaster roaming services. This mechanism is constrained to a specific time and place to minimize the impact on the 5G system and EPS. However, the potential congestion resulting from an influx or outflux of Disaster Inbound Roamers must be taken into account. If a UE has no coverage from its Home Public Land Mobile Network (HPLMN) and registered on a visited PLMN (VPLMN) in 5GS becomes aware that a disaster condition applies to its VPLMN on 5GS, it can register with a VPLMN on EPS offering disaster roaming services.

The requirements for supporting disaster roaming include several key aspects:
1. The 3rd Generation Partnership Project (3GPP) system must support means for a PLMN operator to be aware of the area where a disaster condition applies.
2. The 3GPP system must support the provision of service to Disaster Inbound Roamers only within the specific region where the disaster condition applies.
3. The 3GPP system must provide efficient means for a network to inform Disaster Inbound Roamers that a disaster condition is no longer applicable.
4. The 3GPP system must provide means to enable a UE to access PLMNs in a forbidden PLMN list if a disaster condition applies and no other PLMN is available except for PLMNs in the forbidden PLMN list.

Despite these requirements, existing mechanisms fail to address several critical issues. One such significant problem arises when home PLMN UEs are unable to access services due to a large number of UEs from a different PLMN accessing the disaster roaming services. For instance, if a UE from PLMN A (under 5G service) attempts to access services from PLMN B (a different operator or Radio Access Technology (RAT) without service level agreements with PLMN A), complications arise. PLMN B may be part of the forbidden PLMN list for UE A. However, during a disaster condition, local government mandates may require PLMN B to serve users from PLMN A. When a disaster condition affects PLMN A, UEs from PLMN A may try to register on PLMN B to access services. Consequently, if users from PLMN B attempt to access services, they may be denied of services due to network congestion.

Current mechanisms lack the capability to control and restrict signaling/registration connections from UEs of other PLMNs especially when accessing the network due to disaster condition (e.g., PLMN A) while still allowing UEs belonging to the home network (PLMN B). When networks are overloaded, existing congestion control methods do not differentiate between home network UEs and roaming network UEs, potentially affecting the services of home network UEs providing disaster services. In current 3GPP releases (Release 17 and 18), disaster roaming services are not available in EPS or long term evolution (LTE), and no mechanism exists to perform access barring specifically for UEs registered for disaster roaming services or to restrict new UEs from registering for disaster roaming services in the EPS.

Another issue arises when UEs remain on a disaster roaming PLMN for an extended period, even after the disaster condition on the Home PLMN or RAT has ended. UEs registered for disaster roaming services on a PLMN B or RAT due to a disaster condition on PLMN A may not have a clear mechanism to identify the end of the disaster condition on RAT or PLMN A and transition back. In such cases, PLMN B or RAT must explicitly initiate a network-initiated deregistration procedure to move the UE from PLMN B or RAT to PLMN A or RAT. If PLMN B fails to deregister the UE, it results in a revenue loss for PLMN A or UE may left with limited services.

The term PLMN B can be the same PLMN as PLMN A but providing services on a different RAT throughout the specification.

Throughout the specification, the definitions of the various terms used in the embodiments are as follows:

Disaster Roaming: This is a special roaming policy that applies during a Disaster Condition.

Disaster Condition: This is a condition that a government decides when to initiate and terminate, e.g. a natural disaster. When this condition applies, users may have the opportunity to mitigate service interruptions and failures.

Disaster Inbound Roamer: A user that (a) cannot get service from the PLMN it would normally be served by, due to failure of service during a Disaster Condition, and (b) is able to register with other PLMNs.

Minimization of service interruption (MINT): It is a feature that aims to enable a UE to obtain service from a PLMN offering disaster roaming services when a disaster condition applies to the UE's determined PLMN with disaster condition.

Registered for disaster roaming services: A UE is considered as “registered for disaster roaming services” when it has successfully completed initial registration or mobility registration for disaster roaming services.

Initial registration for disaster roaming services: A registration performed with 5GS registration type “disaster roaming initial registration” in the REGISTRATION REQUEST message.

Mobility registration for disaster roaming services: A registration performed with 5GS registration type “disaster roaming mobility registration updating” in the REGISTRATION REQUEST message.

The 3GPP system supports disaster condition functionality, enabling the UEs to obtain information about a disaster condition affecting a specific PLMN. The system informs PLMN operators of affected areas and allows Disaster Inbound Roamers to receive services within those regions. It also provides mechanisms for informing the UEs when a disaster condition ends and minimizes congestion from disaster roaming. Additionally, the system enables the UEs to access PLMNs on their forbidden list during a disaster condition if no other PLMNs are available. Charging information for disaster inbound roamers includes details about the applied disaster condition. As per 3GPP 24.501 Release 18, interworking with the EPS is not supported for the UEs that are registered for disaster roaming services. When registering for disaster roaming services, the UE indicates to the network that S1 mode is not supported. While registered for disaster roaming services and upon a need to establish an emergency Protocol Data Unit (PDU) session or perform emergency services fallback, the UE initiates the registration procedure for mobility and periodic registration update and indicates that S1 mode is supported.

The following depicts the 3GPP TS 38.331: SIB15 which includes configurations of disaster roaming information.

```
  -- ASN1START
  -- TAG-SIB15-START
```

| | |
|---|---|
| SIB15-r17 ::= | SEQUENCE { |

| | |
|---|---|
| commonPLMNsWithDisasterCondition-r17 | SEQUENCE (SIZE |

| | |
|---|---|
| (1..maxPLMN)) OF PLMN-Identity | OPTIONAL, -- Need R |

| | |
|---|---|
| applicableDisasterInfoList-r17 | SEQUENCE (SIZE |

| | |
|---|---|
| (1..maxPLMN)) OF ApplicableDisasterInfo-r17 | OPTIONAL, -- Need R |

| | |
|---|---|
| lateNonCriticalExtension | OCTET STRING |

```
OPTIONAL,
    ...
  }
```

| | |
|---|---|
| ApplicableDisasterInfo-r17 | ::= CHOICE { |
| noDisasterRoaming-r17 | NULL, |
| disasterRelatedIndication-r17 | NULL, |
| commonPLMNs-r17 | NULL, |
| dedicatedPLMNs-r17 | SEQUENCE (SIZE (1..maxPLMN)) |

```
OF PLMN-Identity
  }
  -- TAG-SIB15-STOP
  -- ASN1STOP
```

The following depicts the SIB15 field descriptions:
commonPLMNsWithDisasterCondition: A list of PLMN(s) for which disaster condition applies and that disaster inbound roaming is accepted, which can be commonly applicable to the PLMNs sharing the cell.
applicableDisasterInfoList: A list indicating the applicable disaster roaming information for the networks indicated in plmn-IdentityInfoList and npn-IdentityInfoList-r16. The network indicates in this list one entry for each entry of plmn-IdentityInfoList, followed by one entry for each entry of npn-IdentityInfoList-r16, meaning that this list will have as many entries as the number of entries of the combination of plmn-IdentityInfoList and npn-IdentityInfoList-r16. The first entry in this list indicates the disaster roaming information applicable for the network(s) in the first entry of plmn-IdentityInfoList/npn-IdentityInfoList-r16, the second entry in this list indicates the disaster roaming information applicable for the network(s) in the second entry of plmn-IdentityInfoList/npn-IdentityInfoList-r16, and so on. Each entry in this list can either be having the value noDisasterRoaming, disasterRelatedIndication, commonPLMNs, or dedicatedPLMNs. If an entry in this list takes the value noDisasterRoaming, disaster inbound roaming is not allowed in this network(s). If an entry in this list takes the value disasterRelatedIndication, the meaning of this field for this network(s) is as specified for “disaster related indication” in TS 23.122 [74], clause 4.4.3.1.1. If an entry in this list takes the value commonPLMNs, the PLMN(s) with disaster conditions indicated in the field commonPLMNsWithDisasterCondition apply for this network(s). If an entry in this list contains the value dedicatedPLMNs, the listed PLMN(s) are the PLMN(s) with disaster conditions that the network(s) corresponding to this entry accepts disaster inbound roamers from. For SNPNs, the network indicates the value noDisasterRoaming.

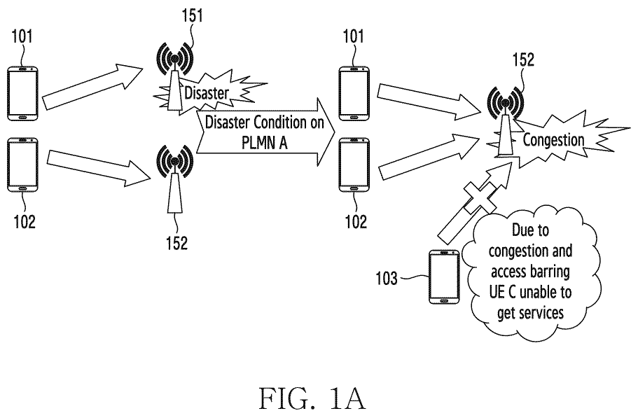

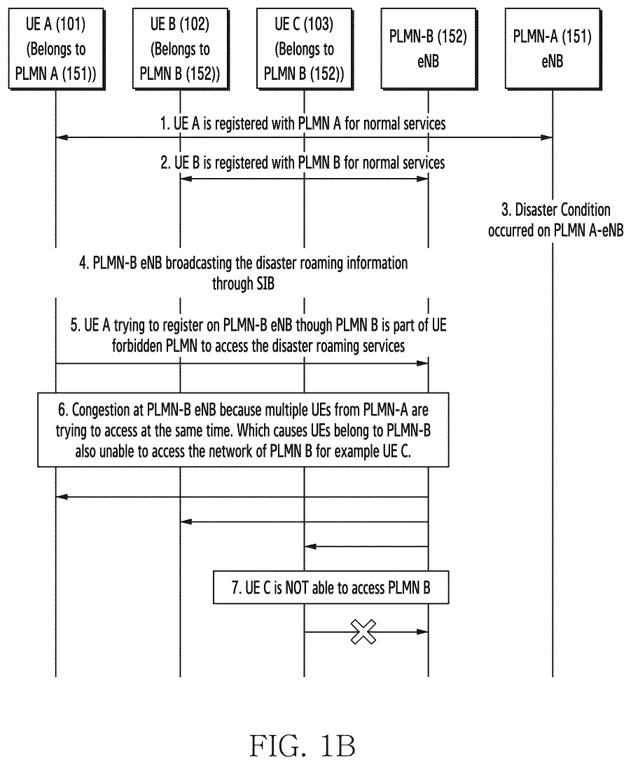

FIG. 1A is a schematic diagram illustrating an existing mechanism for access barring UEs for disaster roaming connections according to the related art. A UE A (101) belongs to a PLMN A (151) and is under 5G service, while a PLMN B (152) is of a different operator and does not have any service level agreements to support UEs belonging to PLMN A (151). The PLMN B (152) is part of the forbidden PLMN of the UE A (101). However, during disaster conditions, as per local government needs, the PLMN B (152) may need to serve users from the PLMN A (151). When a disaster condition occurs on the PLMN A (151), UEs from the PLMN A (151) can try to register on the PLMN B (152) for accessing services. Since the PLMN A (151) is not available, many users of the PLMN A (151) register with the PLMN B (152), causing congestion. Consequently, users belonging to the PLMN B (152) are denied service due to network congestion.

Referring to FIG. 1A, the UE A (101) belongs to the PLMN A (151), the UE B (102) belongs to the PLMN B (152), and the UE C (103) belongs to the PLMN B (152). When the PLMN A (151) experiences a disaster condition and the PLMN B (152) provides disaster roaming services to users of the PLMN A (151), the UE A (101) registers with the PLMN B (152) for disaster roaming services. When congestion occurs at the RAN of the PLMN B (152), the UE C (103) tries to get services from the PLMN B (152) but is unable to do so due to congestion.

FIG. 1B is a sequence diagram illustrating an existing mechanism for access barring UEs for disaster roaming connections according to the related art. Due to multiple UEs accessing the PLMN B (152) after a disaster condition in the PLMN A (151), the PLMN B (152) becomes congested and unable to accept further requests from UEs, including those belonging to the home network. At step 1, a UE A (101) is registered with a PLMN A (151) for normal services. At step 2, a UE B (102) is registered with a PLMN B (152) for normal services. At step 3, a disaster condition occurs on the PLMN A (151) eNB. At step 4, the PLMN B (152) eNB broadcasts disaster roaming information through the SIB. At step 5, the UE A (101) tries to register on the PLMN B (152) eNB, even though the PLMN B (152) is part of the UE forbidden PLMN, to access disaster roaming services. At step 6, congestion occurs at the PLMN B (152) eNB because multiple UEs from the PLMN A (151) are trying to access it simultaneously, causing UEs belonging to the PLMN B (152), such as UE C (103), to be unable to access the network. At step 7, the UE C (103) is not able to access the PLMN B (152).

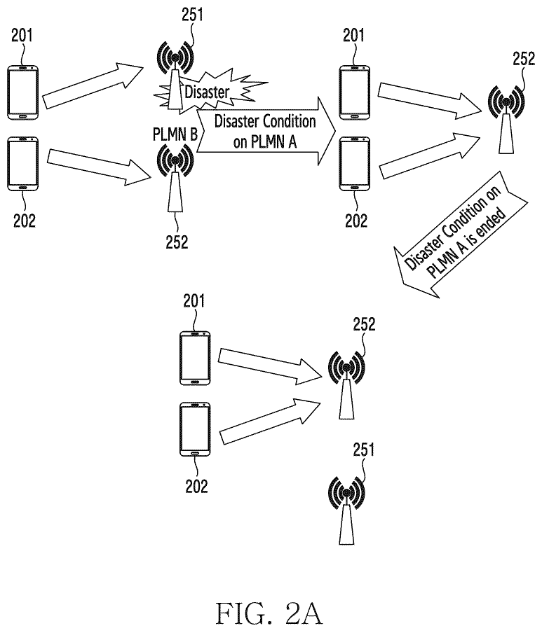

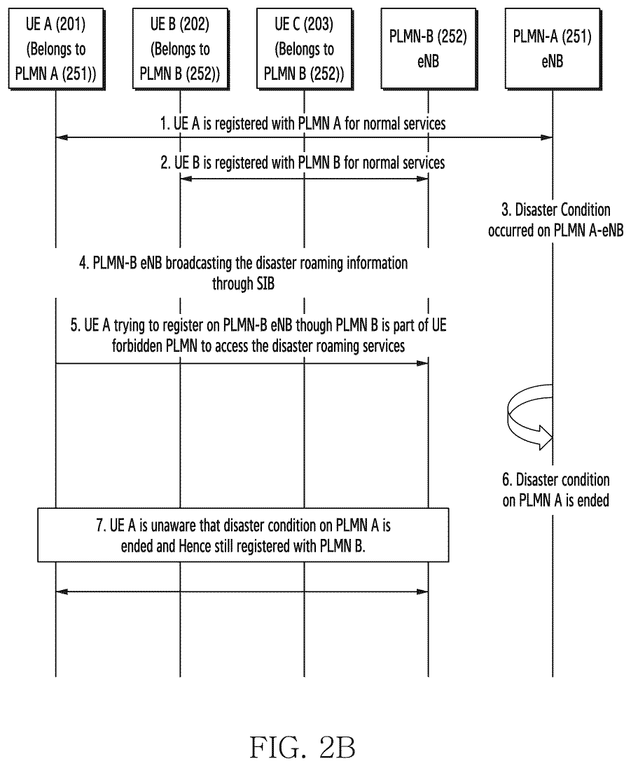

FIG. 2A is a schematic diagram illustrating an existing mechanism where the UE A (201) is unaware that the disaster condition on the PLMN A (251) has ended according to the related art. The UE A (201), due to the disaster condition on the PLMN A (251), has registered on a PLMN B (252) which is providing disaster roaming services. However, the disaster roaming condition on the home PLMN, i.e., the PLMN A (251), has ended, but the UE A (201) is unaware of the situation and may continue to be on the PLMN B (252). If the PLMN B (252) is providing limited services for disaster-roamed UEs, then the UE A (201) will not be able to access the full services possible for a prolonged duration.

Referring to FIG. 2A, the UE A (201) belongs to the PLMN A (251), the UE B (202) belongs to the PLMN B (252), and a UE C belongs to the PLMN B (252). The PLMN A (251) starts experiencing a disaster condition. The PLMN B (252) provides disaster roaming services to users of the PLMN A (251), and the UE A (201) registers with the PLMN B (252) for disaster roaming services. Even after the disaster condition ends on the PLMN A (251), the UE A (201) continues roaming in the PLMN B (252) and is unable to use full services.

FIG. 2B is a sequence diagram illustrating an existing mechanism where the UE A (201) is unaware that the disaster condition on PLMN A (251) has ended according to the related art. Due to multiple UEs accessing the PLMN B (252) after a disaster condition in the PLMN A (251), the PLMN B (252) becomes congested and unable to accept further requests from UEs, including those belonging to the home network. At step 1, a UE A (201) is registered with a PLMN A (251) for normal services. At step 2, a UE B (202) is registered with a PLMN B (252) for normal services. At step 3, a disaster condition occurs on the PLMN A (251) eNB. At step 4, the PLMN B (252) eNB broadcasts disaster roaming information through the SIB. At step 5, the UE A (201) tries to register on the PLMN B (252) eNB, even though the PLMN B (252) is part of the UE forbidden PLMN, to access disaster roaming services. At step 6, after some time, the disaster condition on the PLMN A (251) ends. At step 7, the UE A (201) is unaware that the disaster condition on the PLMN A (251) has ended and remains registered with the PLMN B (252).

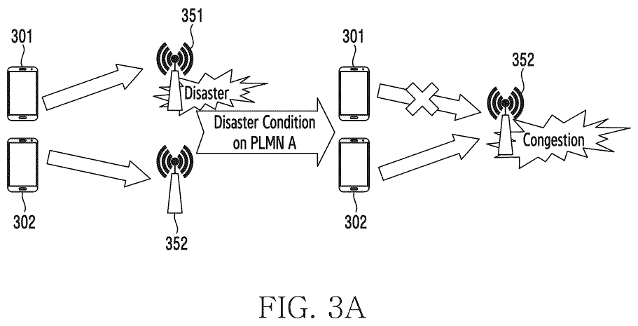

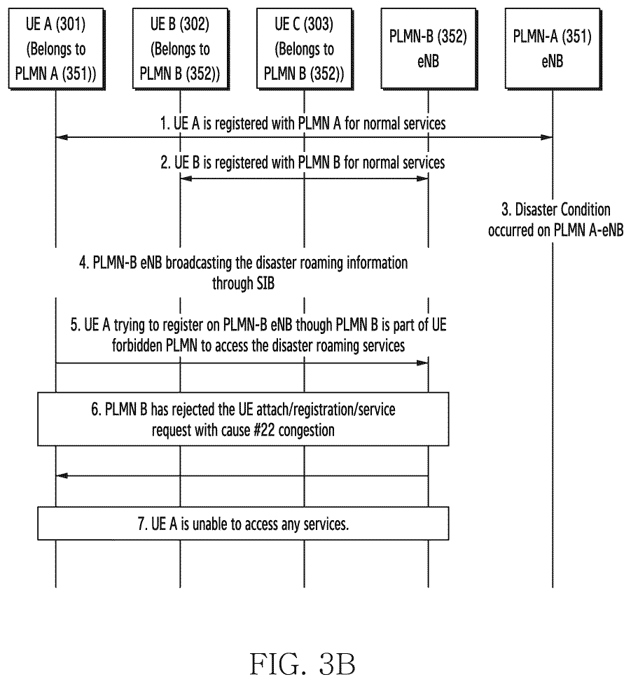

FIG. 3A is a schematic diagram illustrating an existing mechanism where a UE A (301) is unable to get services from a PLMN B (352) due to core network congestion according to the related art. The UE A (301), due to a disaster condition on the PLMN A (351), tries to register on a PLMN B (352) which is offering disaster roaming services. However, due to congestion at the core network, the PLMN B (352) rejects the UE A (301) registration or service request with a reject cause code related to congestion, for example, cause code #22 congestion, resulting in the UE A (301) being unable to access services.

Referring to FIG. 3A, the UE A (301) belongs to the PLMN A (351), and the UE B (302) belongs to the PLMN B (352). The PLMN A (351) starts experiencing a disaster condition, and the PLMN B (352) provides disaster roaming services to users of the PLMN A (351). The UE A (301) tries to register with the PLMN B (352). Due to congestion at the core network of the PLMN B (352), the UE A (301) is unable to get services from the PLMN B (352), with reject cause #22 congestion.

FIG. 3B is a sequence diagram illustrating an existing mechanism where a UE A (301) is unable to get services from a PLMN B (352) due to core network congestion according to the related art. Due to multiple UEs accessing the PLMN B (352) after a disaster condition in the PLMN A (351), the PLMN B (352) becomes congested and unable to accept further requests from UEs, including those belonging to the home network. At step 1, a UE A (301) is registered with a PLMN A (351) for normal services. At step 2, a UE B (302) is registered with a PLMN B (352) for normal services. At step 3, a disaster condition occurs on the PLMN A (351) eNB. At step 4, the PLMN B (352) eNB broadcasts disaster roaming information through the SIB. At step 5, the UE A (301) tries to register on the PLMN B (352) eNB, even though the PLMN B (352) is part of the UE forbidden PLMN, to access disaster roaming services. At step 6, the PLMN B (352) rejects the UE attach/registration/service request with cause #22 congestion. At step 7, the UE A (301) is unable to access any services.

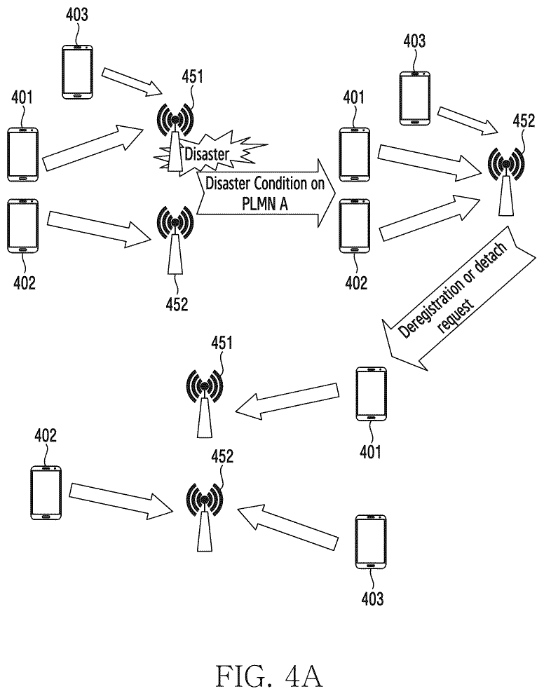

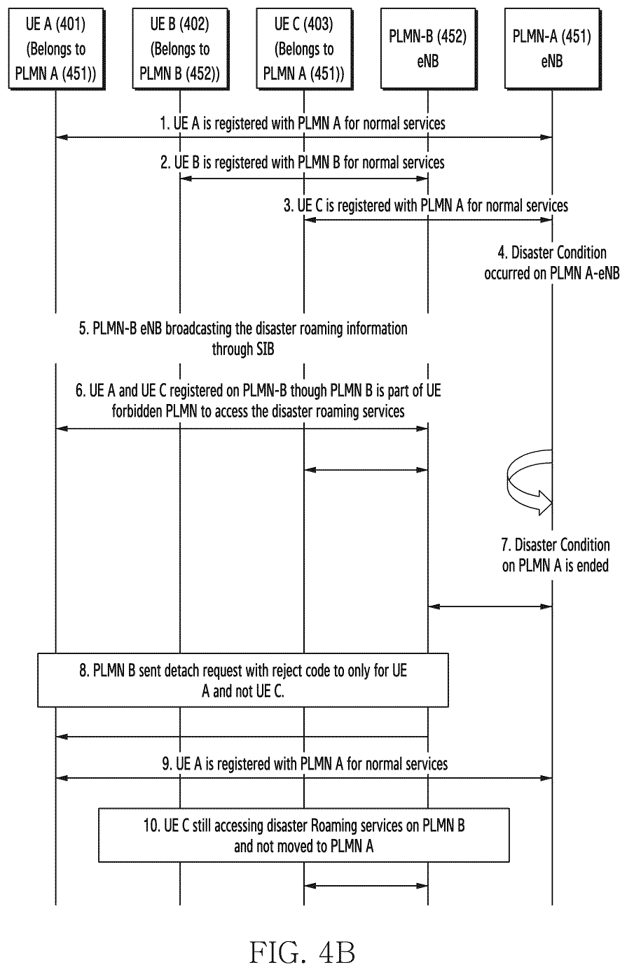

FIG. 4A is a schematic diagram illustrating an existing mechanism where a PLMN B (452) has not sent a detach or deregistration request to a UE C (403) according to the related art. A UE A (401) and a UE C (403), due to a disaster condition on a PLMN A (451), once the PLMN B (452) stops providing disaster roaming services, the PLMN B (452) has to send a detach or deregistration request to roaming UEs so the UEs can register back on the home PLMN or first initial PLMN or VPLMN i.e. PLMN A (451). However, it is possible that the roaming network either delays sending the detach request or avoids sending it so that UEs can stay longer in the roaming network and benefit from more revenue. In the example below, the network sent a detach request to the UE A (401) but not to the UE C (403).

Referring to FIG. 4A, the UE A (401) belongs to the PLMN A (451), the UE B (402) belongs to the PLMN B (452), and the UE C (403) belongs to the PLMN A (451). The PLMN A (451) starts experiencing a disaster condition. The PLMN B (452) provides disaster roaming services to users of the PLMN A (451), and the UE A (401) tries to register with the PLMN B (452) and registers with the network. After disaster roaming support ends on the PLMN B (452), the PLMN B (452) sends a detach or deregistration request with reject cause as PLMN Not allowed to only the UE A (401) but not to the UE C (403).

FIG. 4B is a sequence diagram illustrating an existing mechanism where a PLMN B (452) has not sent a detach or deregistration request to a UE C (403) according to the related art. Due to multiple UEs accessing the PLMN B (452) after a disaster condition in the PLMN A (451), the PLMN B (452) becomes congested and unable to accept further requests from UEs, including those belonging to the home network. At step 1, a UE A (401) is registered with a PLMN A (451) for normal services. At step 2, a UE B (402) is registered with a PLMN B (452) for normal services. At step 3, a UE C (403) is registered with the PLMN A (451) for normal services. At step 4, a disaster condition occurs on the PLMN A (451) eNB. At step 5, the PLMN B (452) eNB broadcasts disaster roaming information through the SIB. At step 6, the UE A (401) and the UE C (403) register on the PLMN B (452) eNB, even though the PLMN B (452) is part of the UE forbidden PLMN, to access disaster roaming services. At step 7, the disaster condition on the PLMN A (451) ends. At step 8, the PLMN B (452) sends a detach request with a reject code to only the UE A (401) and not to the UE C (403). At step 9, the UE A (401) registers with the PLMN A (451) for normal services. At step 10, the UE C (403) still accesses disaster roaming services on the PLMN B (452) and has not moved to the PLMN A (451).

Embodiments disclosed herein provide a UE, a network apparatus, and a method for access barring during disaster roaming in a communication network system. The proposed solution helps networks control the access barring mechanism differently for normal users and disaster roaming users by sending the access barring information for disaster roaming UEs separately through additional System Information Block information. The proposed solution enables the network to activate access barring after a certain threshold of disaster UEs are connected to the network. With the proposed solution, UEs looking for disaster roaming services will identify the network condition and assess the UE allowance to connect with the network or not, thus reducing overall network congestion. The proposed solution allows the UE to identify the end of the disaster roaming condition on the home PLMN and return to the home PLMN faster. Additionally, the UE performs PLMN selection and tries to register on a different PLMN offering disaster roaming services while the initial PLMN offering the services is congested. The proposed solution mitigates the wrong network behavior that keeps the UE longer on the roaming PLMN with deprived or limited services. With the proposed solution, it is possible to get disaster roaming services for the UE from a different PLMN while the initially registered PLMN core network is congested.

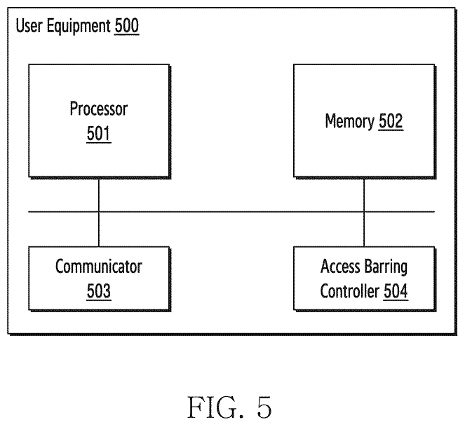

Referring now to the drawings, and more particularly to FIGS. 5 to 10, 11A, 11B, 12A, 12B, 13A, 13B, 14A, and 14B where similar reference characters denote corresponding features consistently throughout the figures, there are shown preferred embodiments.

FIG. 5 is a block diagram illustrating the hardware components associated with the UE according to an embodiment of the disclosure. Examples of the UE (500) can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), and Media Devices (such as Gaming Consoles, Streaming Devices, etc.).

Referring to FIG. 5, the UE (500) supporting includes a processor (501), memory (502), a communicator (503), and an access barring controller (504). The processor (501) is used for access barring during disaster roaming in a communication network system. Communication between the processor (501), the memory (502), the communicator (503), and the access barring controller (504) is facilitated by the processor (501). Instructions stored in the memory (502) are executed by the processor (501), which also is used for access barring during disaster roaming. The processor (501) may include one or a plurality of processors such as a Central Processing Unit (CPU), an Application Processor (AP), a Graphics Processing Unit (GPU), a Visual Processing Unit (VPU), and/or a Neural Processing Unit (NPU).

The memory (502) stores the operating system, application software, and temporary data used by the processor (501). Instructions to be executed by the processor (501) are stored in the memory (502). The memory (502) is not limited to volatile memory and/or non-volatile memory and may include a plurality of computer-readable storage media. Non-volatile storage elements such as magnetic hard disks, optical disks, floppy disks, flash memories, erasable programmable read-only memory (EPROM), or electrically EPROM (EEPROM) memories may be included in the memory (502). In some examples, the memory (502) may be considered a non-transitory storage medium indicating that it is not embodied in a carrier wave or a propagated signal but not necessarily non-movable. The memory (502) stores the AS message received from the network apparatus (600).

The communicator (503) facilitates communication between the UE (500) and the network apparatus (600), supporting various communication protocols such as Transmission Control Protocol/Internet Protocol (TCP/IP), User Datagram Protocol (UDP), and second-generation Digital Video Broadcasting by Satellite (DVB-S2). Internal communication between hardware components via one or more networks is also facilitated by the communicator (503). An electronic circuit specific to a standard that enables wired or wireless communication is included in the communicator (503). The communicator (503) receives the AS message from the network apparatus (600).

In an embodiment, the access barring controller (504) is a hardware component designed for access barring during disaster roaming in a communication network system. This hardware implementation ensures efficient and reliable execution of processes integral to access barring during disaster roaming. The access barring controller (504) includes a multi-core architecture tailored to optimize access barring during disaster roaming in a communication network system. Each core within the architecture is specifically designed to execute distinct functions.

In an embodiment, the access barring controller (504) receives an AS message from the network apparatus (600) providing disaster roaming services for registered UEs (500). The AS broadcast message includes at least one of disaster-related information and access barring indication to be applied to inbound disaster roaming UEs. The access barring controller (504) determines whether the UE (500) is barred from using disaster roaming services from the network apparatus (600) based on the received AS message. It performs a barring check for disaster roaming by a Radio Resource Control (RRC) layer of the UE (500) based on the access barring information received from the network apparatus (600) and a notification from the NAS layer to the AS layer where the notification indicates an establishment cause indicating disaster roaming or a call type indicating disaster roaming. The access barring controller (504) is configured to determine access barring based on the PLMN identification (ID), cell ID, TAI, or RAT information included in the AS message.

In an embodiment, the access barring controller (504) prevents attempts to register or send any NAS or AS signaling message on the network apparatus (600) providing the disaster roaming services for registering or sending the NAS or AS signaling message for disaster roaming services in response to determining that the UE (500) is barred from using the disaster roaming services from the network apparatus (600). The access barring controller (504) inhibits the UE (500) from initiating NAS or AS signaling messages on one or more of the network apparatus (600), Tracking Area Identity (TAI) associated with the disaster roaming PLMN, PLMN ID associated with the PLMN, and a RAT associated with the disaster roaming PLMN. It prevents the UE (500) that is already registered for the disaster roaming services from attempting to access the disaster roaming PLMN for Mobile Originated (MO) signaling or MO data including for the disaster roaming services based on the access barring indication. The access barring controller (504) performs a PLMN search to identify and register to another PLMN and is configured to determine access barring based on the PLMN ID, cell ID, TAI, or RAT information included in the AS message. Further, the access barring controller (504) allows attempts to register or send any NAS or AS signaling message on the disaster roaming network apparatus (600) for registering or sending the NAS or AS signaling message for disaster roaming services in response to determining that the UE (500) is not barred from using the disaster roaming services from the network apparatus (600).

In an embodiment, the access barring controller (504) receives SIB information broadcasted by the network apparatus (600), determines whether a home PLMN (HPLMN) or an equivalent home PLMN (EHPLMN) or first initial PLMN or VPLMN is not part of a list of common PLMNs with disaster conditions, determines that the disaster condition in the HPLMN or EHPLMN has ended when the HPLMN or the EHPLMN or first initial PLMN or VPLMN is not part of the list of common PLMNs with disaster conditions, and deregisters from the serving network apparatus (600) upon determining that the disaster condition has ended on the HPLMN or the EHPLMN or first initial PLMN or VPLMN. Further, the access barring controller (504) returns to the HPLMN or EHPLMN or first initial PLMN or VPLMN and adds the current serving network apparatus (600) providing disaster roaming services to a forbidden PLMN list to prevent immediate re-access to the network apparatus (600). When only a set of the registered UEs with the disaster roaming PLMN for disaster roaming services receives a detach or deregistration request, the access barring controller (504) identifies the HPLMN or the EHPLMN or first initial PLMN or VPLMN is not part of a list of common PLMNs with disaster conditions and performs the PLMN search and identifies the availability of the HPLMN or the EHPLMN or first initial PLMN or VPLMN or any allowed available PLMN and registers on the PLMN by sending a NAS message such as attach request or tracking area update request or service request.

In an embodiment, the access barring controller (504) registers with a HPLMN or an EHPLMN or first initial PLMN or VPLMN for normal services, detects a disaster condition on the HPLMN or the EHPLMN or first initial PLMN or VPLMN, registers with a disaster roaming PLMN in response to the detected disaster condition where the disaster roaming PLMN is initially part of a forbidden PLMN list for the UE, receives a reject message due to core network congestion with a cause code from the network apparatus (600), performs a PLMN search to find a third PLMN providing the disaster roaming services where the third PLMN is different from both the HPLMN and the current serving network apparatus (600), and registers with the third PLMN to maintain or access the disaster roaming services. The access barring controller (504) is connected to the network apparatus (600) during disaster roaming and is able to access the third PLMN upon successful registration to continue receiving disaster roaming services.

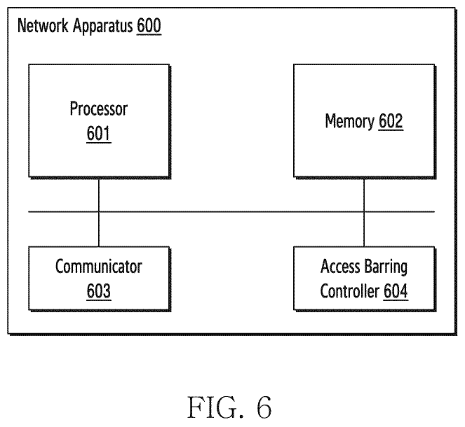

FIG. 6 is a block diagram illustrating the hardware components associated with the network apparatus (600) according to an embodiment of the disclosure. Examples of the network apparatus (600) can include, but are not limited to, Base Stations (such as macro cells, small cells, femtocells, picocells) for wireless communication, Antennas and RF Units (e.g., multiple input multiple output (MIMO), beamforming) to enhance signal coverage and data throughput, Core Network Equipment (e.g., MMEs, S-GWs, P-GWs in 4G, AMFs, UPFs in 5G) for data routing, mobility, and session control, Network function Virtualization (NFV) and Software-Defined Networking (SDN) for dynamic resource allocation and scalability, Edge Computing Nodes (e.g., MEC servers) for low-latency processing, Backhaul and Transport Equipment (e.g., fiber-optic links, microwave relays, Ethernet switches) to connect base stations to the core network, Network Management Systems (NMS) and Operation Support Systems (OSS) for network configuration, fault management, and optimization, Radio Network Controllers (RNCs) in 3G, Distributed Units (DUs) and Centralized Units (CUs) in 5G, Network Slicing Components for virtualized resource allocation, Security elements (e.g., Firewalls, IDS, AAA Servers) for secure communication.

Referring to FIG. 6, the network apparatus (600) includes a processor (601), memory (602), a communicator (603), and an access barring controller (604). The processor (601) is used for access barring during disaster roaming in a communication network system. Communication between the processor (601), the memory (602), the communicator (603), and the access barring controller (604) is facilitated by the processor (601). Instructions stored in the memory (602) are executed by the processor (601), which also is used for access barring during disaster roaming. The processor (601) may include one or a plurality of processors such as a Central Processing Unit (CPU), an Application Processor (AP), a Graphics Processing Unit (GPU), a Visual Processing Unit (VPU), and/or a Neural Processing Unit (NPU).

The memory (602) stores the operating system, application software, and temporary data used by the processor (601). Instructions to be executed by the processor (601) are stored in the memory (602). The memory (602) is not limited to volatile memory and/or non-volatile memory and may include a plurality of computer-readable storage media. Non-volatile storage elements such as magnetic hard disks, optical disks, floppy disks, flash memories, EPROM, or EEPROM memories may be included in the memory (602). In some examples, the memory (602) may be considered a non-transitory storage medium indicating that it is not embodied in a carrier wave or a propagated signal but not necessarily non-movable. The memory (602) stores the AS message created for sending it to the UE (500) during the disaster.

The communicator (603) facilitates communication between the UE (500) and the network apparatus (600), supporting various communication protocols such as Transmission Control Protocol/Internet Protocol (TCP/IP), User Datagram Protocol (UDP), and second-generation Digital Video Broadcasting by Satellite (DVB-S2). Internal communication between hardware components via one or more networks is also facilitated by the communicator (603). An electronic circuit specific to a standard that enables wired or wireless communication is included in the communicator (603). The communicator (603) sends the AS message to the UE (500) during the disaster.

In an embodiment, the access barring controller (604) is a hardware component designed for access barring during disaster roaming in a communication network system. This hardware implementation ensures efficient and reliable execution of processes integral to access barring during disaster roaming. The access barring controller (604) includes a multi-core architecture tailored to optimize access barring during disaster roaming in a communication network system. Each core within the architecture is specifically designed to execute distinct functions.

In an embodiment, the access barring controller (604) creates an AS message including disaster-related information and access barring indication to be applied to inbound disaster roaming UE. The network apparatus (600) is providing disaster roaming services to the UE (500). Further, the access barring controller (604) sends or broadcasts the AS message to the UE (500) during the disaster.

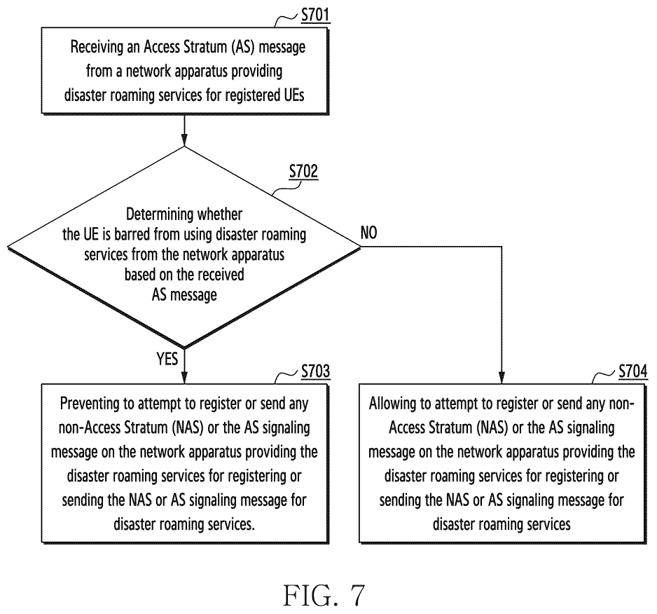

FIG. 7 is a flow diagram illustrating a proposed method for access barring during disaster roaming in a communication network system by the UE (500) according to an embodiment of the disclosure. At operation S701, the method includes receiving by a UE (500) an AS message from a network apparatus (600) providing disaster roaming services for registered UEs (500). The AS broadcast message includes at least one of disaster-related information and access barring indication to be applied to inbound disaster roaming UEs. The UE (500) receives the AS message on the network apparatus (600) in response to a disaster event in a network coverage area of the UE (500). The AS message includes one or more signaling messages or System Information Block information, which can include but is not limited to SIB-1, SIB-2, SIB-X.

At operation S702, the method includes determining by the UE (500) whether the UE (500) is barred from using disaster roaming services from the network apparatus (600) based on the received AS message. This determination includes performing a barring check for disaster roaming by a RRC layer of the UE (500) based on the access barring information received from the network apparatus (600) and a notification from the NAS layer to the AS layer. The notification indicates an establishment cause or a call type indicating disaster roaming. The access barring indication includes information related to access barring for disaster roaming services as sent by the network apparatus (600). The UE (500) is configured to determine access barring based on the PLMN ID, cell ID, TAI, or RAT information included in the AS message.

At operation S703, the method includes preventing by the UE (500) from attempting to register or send any non-Access Stratum (NAS) or AS signaling message on the network apparatus (600) providing the disaster roaming services. This prevention occurs in response to determining that the UE (500) is barred from using the disaster roaming services from the network apparatus (600). The UE (500) performs one or more actions based on the access barring indication, such as inhibiting the UE (500) from initiating NAS or AS signaling messages on at least one of the network apparatus (600), TAI associated with the disaster roaming PLMN, PLMN ID associated with the PLMN, and RAT associated with the disaster roaming PLMN. Additionally, the UE (500) prevents attempts to access the disaster roaming PLMN for MO signaling or MO data, including for disaster roaming services based on the access barring indication. Further, the method includes performing by the UE (500) a PLMN search to identify and register to another PLMN. The network apparatus (600) includes a Visited Public Land Mobile Network (VPLMN) providing disaster roaming services on an Evolved Packet System (EPS).

At operation S704, the method includes allowing by the UE (500) to attempt to register or send any NAS or AS signaling message on the network apparatus (600) providing the disaster roaming services. This allowance occurs in response to determining that the UE (500) is not barred from using the disaster roaming services from the network apparatus (600).

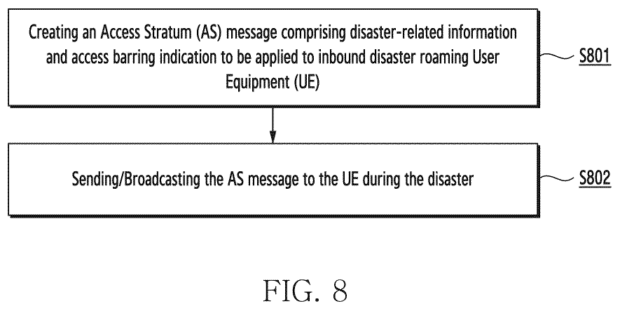

FIG. 8 is a flow diagram illustrating a proposed method for access barring during disaster roaming in a communication network system by the network apparatus (600) according to an embodiment of the disclosure. At operation S801, the method includes creating by a network apparatus (600) an AS message including disaster-related information and access barring indication to be applied to inbound disaster roaming UE. The network apparatus (600) is providing disaster roaming services to the UE (500). The AS message includes one or more signaling messages or System Information Block information, which can include but is not limited to SIB-1, SIB-2, SIB-X. The access barring indication includes information related to access barring for disaster roaming services as sent by the network apparatus (600). Further, the access barring indications are provided in the same AS message containing disaster-related information or in a separate SIB message from the one containing disaster-related information. At operation S802, the method includes sending by the network apparatus (600) the AS message to the UE (500) during the disaster. The network apparatus (600) includes a VPLMN providing disaster roaming services on an EPS.

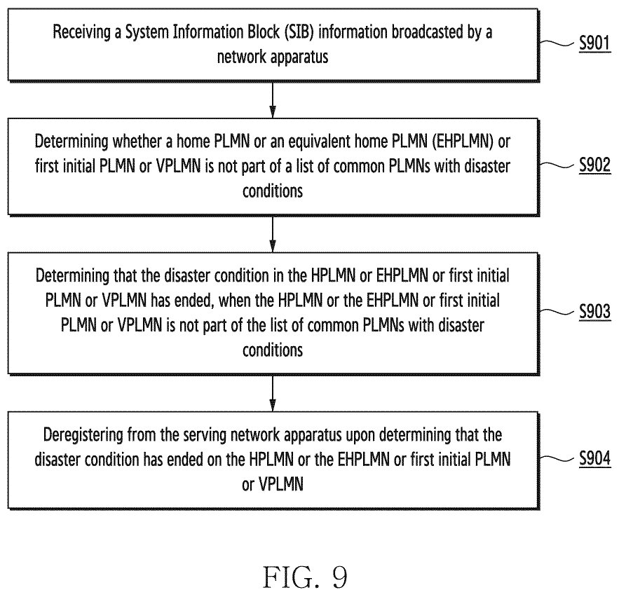

FIG. 9 is a flow diagram illustrating another proposed method for access barring during disaster roaming in a communication network system by the UE (500) according to an embodiment of the disclosure. At operation S901, the method includes receiving, by a UE (500), SIB information broadcasted by a network apparatus (600). At operation S902, the method includes determining, by the UE (500), whether an HPLMN or an EHPLMN or first initial PLMN or VPLMN is not part of a list of common PLMNs with disaster conditions. At operation S903, the method includes determining, by the UE (500), that the disaster condition in the HPLMN or EHPLMN or first initial PLMN or VPLMN has ended when the HPLMN or the EHPLMN or first initial PLMN or VPLMN is not part of the list of common PLMNs with disaster conditions. At operation S904, the method includes deregistering, by the UE (500), from the serving network apparatus (600) upon determining that the disaster condition has ended on the HPLMN or the EHPLMN or first initial PLMN or VPLMN. Further, the method includes returning, by the UE (500), to the HPLMN or EHPLMN or first initial PLMN or VPLMN and adding, by the UE (500), the current serving network apparatus (600) to a forbidden PLMN list to prevent immediate re-access to the network apparatus (600). Furthermore, when only a set of the registered UEs with the disaster roaming PLMN for disaster roaming services receives a detach or deregistration request, the method includes identifying, by the UE (500), that the HPLMN or the EHPLMN or first initial PLMN or VPLMN is not part of a list of common PLMNs with disaster conditions and performing, by the UE (500), the PLMN search and identifying the availability of the HPLMN or the EHPLMN or first initial PLMN or VPLMN or any allowed available PLMN and registering on the PLMN by sending a NAS message such as attach request or tracking area update request or service request.

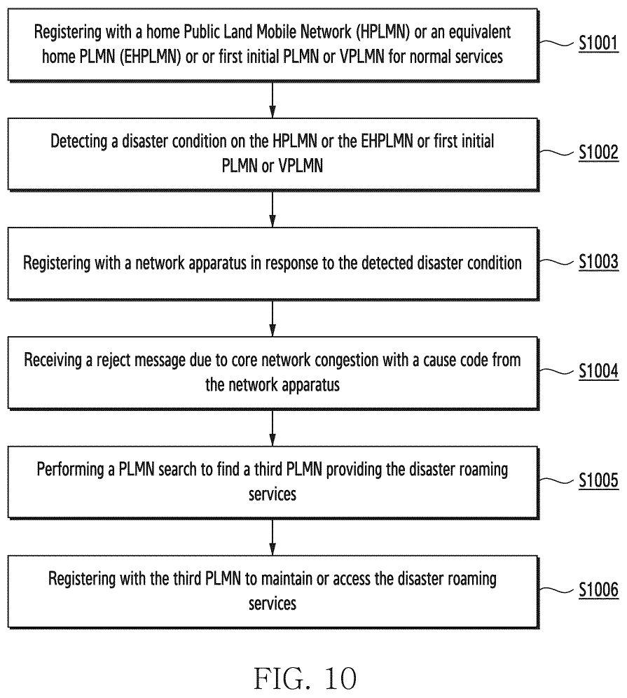

FIG. 10 is a flow diagram illustrating yet another proposed method for access barring during disaster roaming in a communication network system by the UE (500) according to an embodiment of the disclosure. At operation S1001, the method includes registering, by a UE (500), with an HPLMN or an EHPLMN or first initial PLMN or VPLMN for normal services. At operation S1002, the method includes detecting, by the UE (500), a disaster condition on the HPLMN or the EHPLMN or first initial PLMN or VPLMN. At operation S1003, the method includes registering, by the UE (500), with a network apparatus (600) in response to the detected disaster condition, where the network apparatus (600) is initially part of a forbidden PLMN list for the UE (500). The UE (500) is connected to the network apparatus (600) during disaster roaming. At operation S1004, the method includes receiving, by the UE (500), a reject message due to core network congestion with a cause code from the network apparatus (600). The reject cause code is cause #22 indicating congestion. At operation S1005, the method includes performing, by the UE (500), a PLMN search to find a third PLMN providing the disaster roaming services, where the third PLMN is different from both the HPLMN and the current serving network apparatus (600). The UE (500) is able to access the third PLMN upon successful registration to continue receiving disaster roaming services. At operation S1006, the method includes registering, by the UE (500), with the third PLMN to maintain or access the disaster roaming services. The network apparatus (600) is operated by a different network operator than the HPLMN, and the third PLMN is operated by a different network operator than the current serving network apparatus (600) to the UE (500).

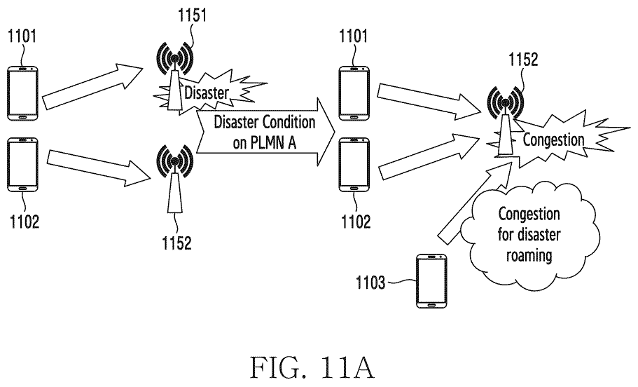

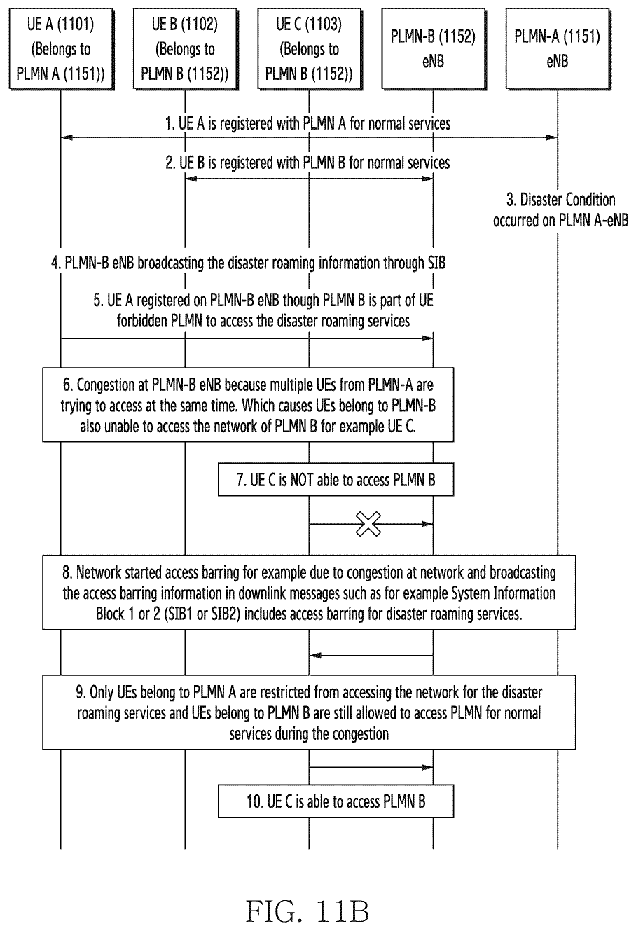

FIG. 11A is a schematic diagram illustrating the proposed mechanism where NW broadcasts the SIB with disaster roaming access bar information according to the embodiments as disclosed herein. In an embodiment, the NW broadcasts the SIB with additional details related to access barring for disaster roaming services while still allowing access for normal users. The NW is able to control disaster roaming UEs differently than home users, thus allowing home users to still receive normal services in a congestion state. As a result, when congestion occurs at the UE side, only disaster roaming UEs are deprived of services while normal users are still able to access the network services.

Referring to FIG. 11A, a UE A (1101) belongs to a PLMN A (1151), a UE B (1102) belongs to a PLMN B (1152), and a UE C (1103) belongs to the PLMN B (1152). The PLMN A (1151) has started experiencing a disaster condition, and the PLMN B (1152) is providing disaster roaming services to users of the PLMN A (1151). The UE A (1101) has registered with the PLMN B (1152) for disaster roaming services. When congestion occurs at the RAN of the PLMN B (1152), since the NW has broadcasted the disaster access barring information through the SIB, only the UEs trying to access the PLMN B (1152) for disaster roaming services are not allowed, and the UE C (1103) is able to access the network for normal services.

FIG. 11B is a sequence diagram illustrating the proposed mechanism where NW broadcasts the SIB with disaster roaming access bar information according to the embodiments as disclosed herein. In an embodiment, the NW broadcasts additional information through the SIB indicating access is barred for disaster roaming services. Hence, HPLMN UEs are still able to access the network for normal services, i.e., UE C (1103) is able to register with the NW. At step 1, a UE A (1101) is registered with a PLMN A (1151) for normal services. At step 2, a UE B (1102) is registered with a PLMN B (1152) for normal services. At step 3, a disaster condition occurs on the PLMN A (1151) eNB. At step 4, the PLMN B (1152) eNB broadcasts the disaster roaming information through the SIB. At step 5, the UE A (1101) registers on the PLMN B (1152) eNB, though the PLMN B (1152) is part of the UE's forbidden PLMN list to access the disaster roaming services. At step 6, congestion occurs at the PLMN B (1152) eNB because multiple UEs from the PLMN A (1151) are trying to access it at the same time, causing UEs belonging to the PLMN B (1152) to also be unable to access the network of PLMN B (1152), for example, UE C (1103). At step 7, the UE C (1103) is not able to access the PLMN B (1152). At step 8, the network starts access barring, for example, due to congestion at the network, and broadcasts the access barring information in downlink messages such as System Information Block 1 or 2 (SIB1 or SIB2), which includes access barring for disaster roaming services. At step 9, only UEs belonging to the PLMN A (1151) are restricted from accessing the network for disaster roaming services, while UEs belonging to the PLMN B (1152) are still allowed to access the PLMN for normal services during the congestion. At step 10, the UE C (1103) is able to access the PLMN B (1152).

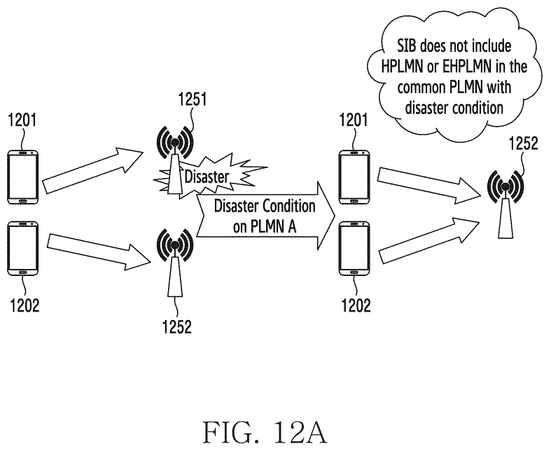

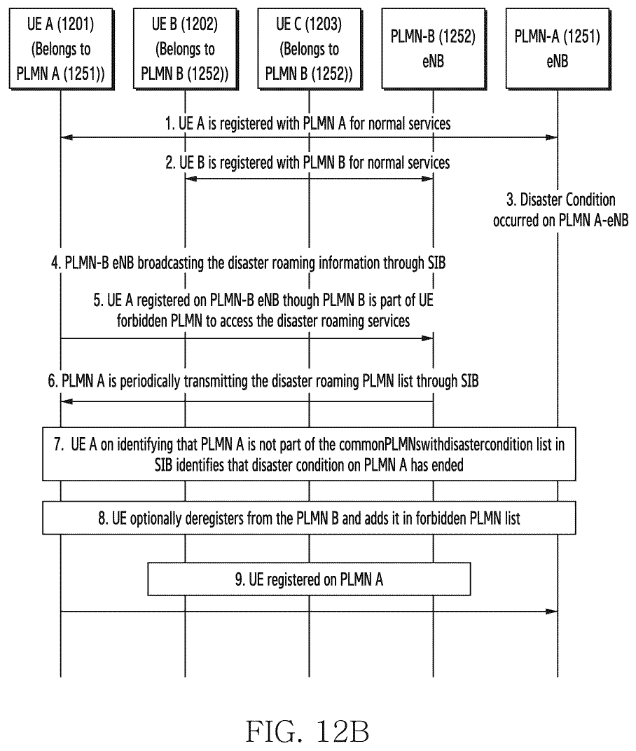

FIG. 12A is a schematic diagram illustrating a proposed mechanism where the UE identifies the end of a disaster roaming condition through a disaster PLMN list in the SIB, according to an embodiment of the disclosure. In an embodiment, the UE reads the SIB information broadcasted by the disaster roaming PLMN and identifies that the home PLMN or EHPLMN or first initial PLMN or VPLMN is not part of the commonPLMNsWithDisasterCondition, thus determining that the disaster condition on the HPLMN has ended. Upon identifying that the home PLMN or EHPLMN or first initial PLMN or VPLMN is not part of the commonPLMNsWithDisasterCondition, the UE deregisters from the serving PLMN. The UE returns to the HPLMN or EHPLMN or first initial PLMN or VPLMN faster and may additionally add the current serving disaster roaming PLMN to the forbidden back-off list, so the UE can access the PLMN again for disaster roaming services.

Referring to FIG. 12A, a UE A (1201) belongs to a PLMN A (1251), a UE B (1202) belongs to a PLMN B (1252), and a UE C (1203) belongs to the PLMN B (1252). The PLMN A (1251) has started experiencing a disaster condition, and the PLMN B (1252) is providing disaster roaming services to users of the PLMN A (1251). The UE A (1201) has registered with the PLMN B (1252) for disaster roaming services. Congestion occurred at the RAN of the PLMN B (1252). The UE A (1201) identifies that the PLMN A (1251) is not part of the commonPLMNsWithDisasterCondition and determines that the disaster condition on the PLMN A (1251) has ended. Optionally, if the UE has an EHPLMN and it is also not part of the commonPLMNsWithDisasterCondition, the UE deregisters from the disaster roaming PLMN.

FIG. 12B is a sequence diagram illustrating a proposed mechanism where the UE identifies the end of a disaster roaming condition through a disaster PLMN list in the SIB, according to an embodiment of the disclosure. In an embodiment, a UE reads the SIB information containing the disaster PLMN list and considers the absence of the HPLMN or last registered PLMN from the disaster common PLMN list, identifying that the disaster condition on those PLMNs has ended. At step 1, a UE A (1201) is registered with a PLMN A (1251) for normal services. At step 2, a UE B (1202) is registered with a PLMN B (1252) for normal services. At step 3, a disaster condition occurs on the PLMN A (1251) eNB. At step 4, the PLMN B (1252) eNB broadcasts the disaster roaming information through the SIB. At step 5, the UE A (1201) registers on the PLMN B (1252) eNB, even though the PLMN B (1252) is part of the UE's forbidden PLMN list, to access the disaster roaming services. At step 6, the PLMN A (1251) periodically transmits the disaster roaming PLMN list through the SIB. At step 7, the UE A (1201) identifies that the the PLMN A (1251) is not part of commonPLMNsWithDisasterCondition list in the SIB and determines that the disaster condition on the PLMN A (1251) has ended. At step 8, the UE A (1201) optionally deregisters from the PLMN B and adds it to the forbidden PLMN list. At step 9, the UE A (1201) registers on the PLMN A (1251).

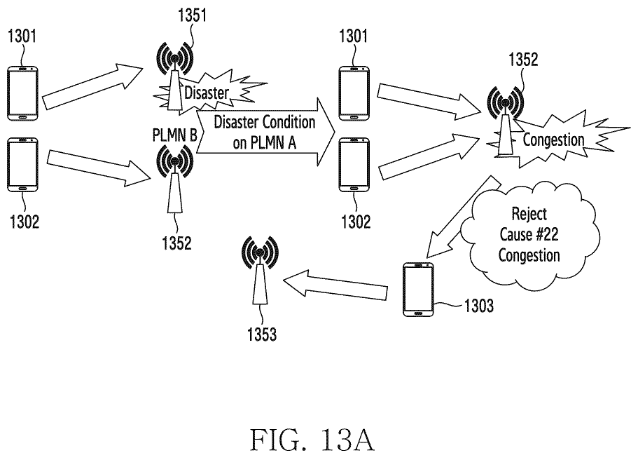

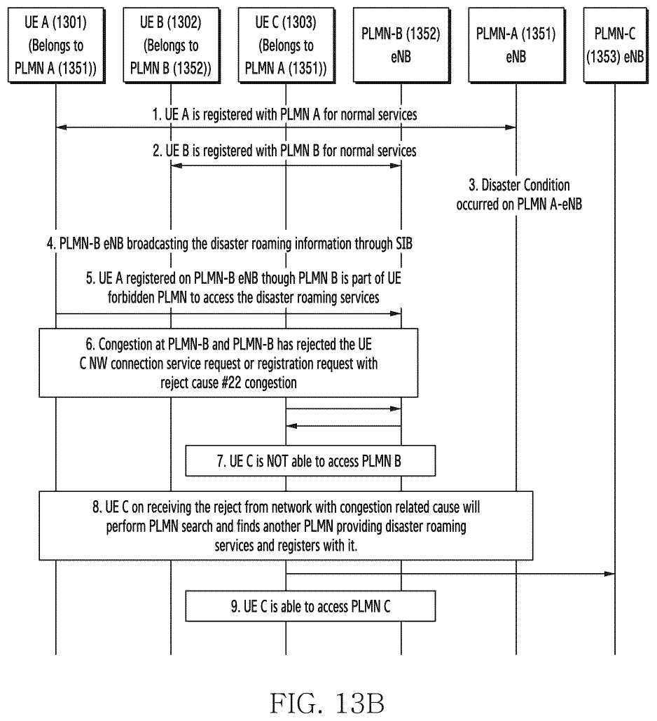

FIG. 13A is a schematic diagram illustrating a proposed mechanism where the UE performs PLMN selection and registration based on a reject cause, according to an embodiment of the disclosure. In an embodiment, when a UE is registered with the NW for disaster roaming services and receives a reject cause from the network, such as cause #22 congestion, the UE may perform a PLMN search to check for other available PLMNs that can provide disaster roaming services and register on that PLMN. As a result, when congestion occurs on the network side, the UE will still be able to receive disaster roaming services without being stuck on the initial disaster roaming provided PLMN when multiple PLMNs are providing disaster roaming services.

Referring to FIG. 13A, a UE A (1301) belongs to a PLMN A (1351), a UE B (1302) belongs to a PLMN B (1352), and a UE C (1303) belongs to the PLMN A (1351). The PLMN A (1351) has started experiencing a disaster condition, and the PLMN B (1352) is providing disaster roaming services to users of the PLMN A (1351). The UE A (1301) has registered with the PLMN B (1352) for disaster roaming services. Congestion has occurred at the core network of the PLMN B (1352). Since the network has issued a congestion reject cause code to the UE C (1303), the UE C (1303) performs a PLMN search and registers on another PLMN that is providing disaster roaming services, in this case, the PLMN C (1453).

FIG. 13B is a sequence diagram illustrating a proposed mechanism where the UE performs PLMN selection and registration based on a reject cause, according to an embodiment of the disclosure. In an embodiment, a UE C (1303) belonging to a PLMN A (1351) attempts to register on a PLMN B (1352) after a disaster condition occurs, but the NW rejects the connection with reject cause #22 congestion. Consequently, the UE C (1303) initiates a PLMN search to register on another PLMN providing disaster roaming services, i.e., the PLMN C (1453), and registers onto it. At step 1, the UE A (1301) is registered with the PLMN A (1351) for normal services. At step 2, the UE B (1302) is registered with the PLMN B (1352) for normal services. At step 3, a disaster condition occurs on the PLMN A (1351) eNB. At step 4, the PLMN B (1352) eNB broadcasts the disaster roaming information through the SIB. At step 5, the UE A (1301) registers on the PLMN B (1352) eNB, even though the PLMN B (1352) is part of the UE's forbidden PLMN list, to access the disaster roaming services. At step 6, congestion occurs at the PLMN B (1352), and the PLMN B (1352) rejects the UE C (1303) NW connection service request or registration request with reject cause #22 congestion. At step 7, the UE C (1303) is unable to access the PLMN B (1352). At step 8, the UE C (1303), upon receiving the reject from the network with a congestion-related cause, performs a PLMN search and finds another PLMN providing disaster roaming services and registers with it. At step 9, the UE C (1303) is able to access the PLMN C (1453).

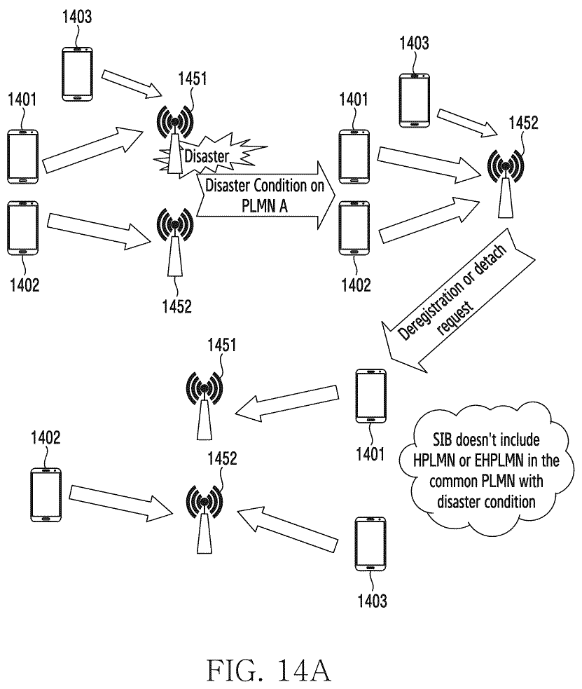

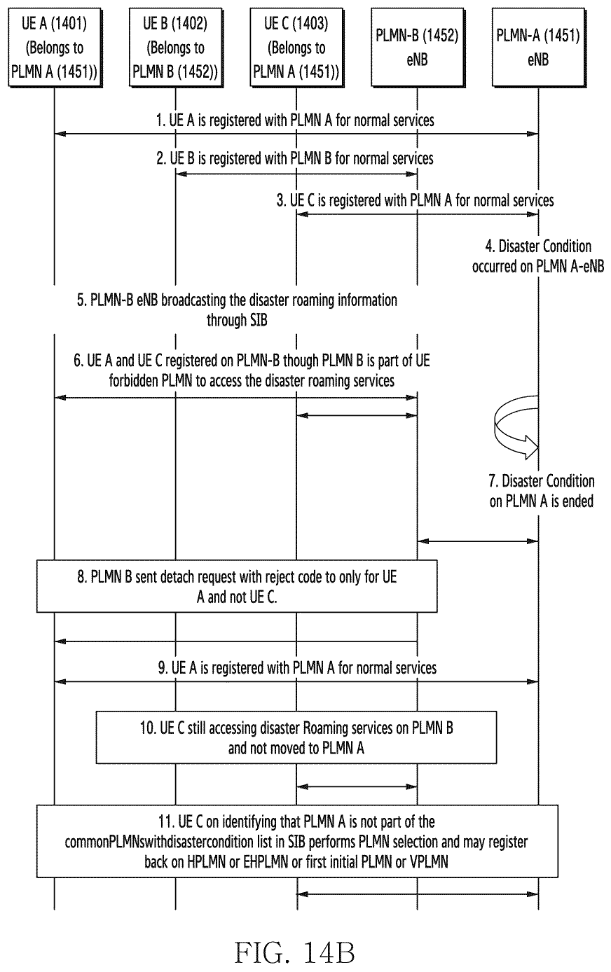

FIG. 14A is a schematic diagram illustrating the proposed mechanism for a faster return to HPLMN or EHPLMN or first initial PLMN or VPLMN according to an embodiment of the disclosure. In one embodiment, upon identifying that the HPLMN or EHPLMN or first initial PLMN or VPLMN is not part of the common PLMN list for disaster conditions, the system will identify that the disaster condition on PLMN A (1451) has ended. Consequently, it performs a PLMN search request and registers back on HPLMN or EHPLMN or first initial PLMN or VPLMN for normal services, enabling a quick and independent return to normal services.

Referring to FIG. 14A, UE A (1401) belongs to PLMN A (1451), UE B (1402) belongs to PLMN B (1452), and UE C (1403) belongs to PLMN A (1451). When PLMN A (1451) experiences a disaster condition, PLMN B (1452) provides disaster roaming services to users of PLMN A (1451). UE A (1401) attempts to register with PLMN B (1452) and successfully registers with the network. After disaster roaming support ends on PLMN B (1452), PLMN B (1452) sends a detach or deregistration request with the reject cause “PLMN Not allowed” to UE A (1401) but not to UE C (1403). Based on the SIB information about the disaster PLMN list, UE C (1403) identifies that PLMN A (1451) is no longer in a disaster condition, deregisters from PLMN B (1452), and registers back on PLMN A (1451).

FIG. 14B is a sequence diagram illustrating the proposed mechanism where UE performs a PLMN search based on the end of a disaster condition according to an embodiment of the disclosure. In one embodiment, the network broadcasts additional information through the SIB indicating that access is barred for disaster roaming services. Consequently, HPLMN UEs can still access the network for normal services. For instance, UE C (1403) is able to register with the network. The steps are as follows:
1. UE A (1401) registers with PLMN A (1451) for normal services.
2. UE B (1402) registers with PLMN B (1452) for normal services.
3. UE C (1403) registers with PLMN A (1451) for normal services.
4. A disaster condition occurs on PLMN A (1451) eNB.
5. PLMN B (1452) eNB broadcasts disaster roaming information through the SIB.
6. UE A (1401) and UE C (1403) register on PLMN B (1452) eNB, even though PLMN B (1452) is part of the UE forbidden PLMN list for accessing disaster roaming services.
7. The disaster condition on PLMN A (1451) ends.
8. PLMN B (1452) sends a detach request with a reject code only to UE A (1401) and not to UE C (1403).
9. UE A (1401) registers with PLMN A (1451) for normal services.
10. UE C (1403) continues accessing disaster roaming services on PLMN B (1452) and does not move to PLMN A (1451).
11. UE C (1403), upon identifying that PLMN A (1451) is not part of the common PLMNs with disaster condition list in the SIB, performs PLMN selection and registers back on HPLMN or EHPLMN or first initial PLMN or VPLMN.

In one embodiment, the proposed solutions help networks to allow or bar UEs of the home network versus UEs of disaster roaming during congestion scenarios. Users can quickly return to the home network as soon as the disaster condition ends.

With the proposed solution depicted in FIG. 11B, the network can still provide normal services for all users and also provide disaster roaming services within its capacity without degrading service for home users. Another proposed solution, illustrated in FIG. 12B, enables users to quickly return to the HPLMN and access full services supported on the HPLMN/EHPLMN or first initial PLMN or VPLMN, or else only limited services are available through the disaster roaming PLMN. Yet another proposed solution, illustrated in FIG. 13B, allows users to search and register on other available disaster roaming service-providing PLMNs during core network congestion. Without this solution, UEs must wait in the initially registered disaster roaming PLMN until the congestion timer expires to avail services. The solution illustrated in FIG. 14B enables users to quickly return to the HPLMN and access full services supported on the HPLMN/EHPLMN, or first initial PLMN or VPLMN or else only limited services are available through the disaster roaming PLMN.

In one embodiment, the proposed solution can be implemented in the eNB at the network side to broadcast additional system information block details containing information to access bar UEs trying to connect with the network for disaster roaming services. UEs verify the disaster roaming access barring information from the SIB and evaluate whether the UE is allowed to access the network, thus reducing overall network congestion while it is still congested. UEs identify and monitor the disaster PLMN list in the SIB, and once it is identified that its HPLMN is no longer present in the list, it will try to register back on the HPLMN or EHPLMN or first initial PLMN or VPLMN. UEs receiving a reject cause from the network start performing a PLMN search and try to register on the next best available PLMN for disaster roaming services.

In one embodiment, during disaster roaming when one PLMN encounters a disaster condition, other PLMNs can provide services to users of the affected PLMN. Since all UEs from the disaster condition PLMN will try to register on other PLMNs providing services, it congests the network not only for roaming users but also for users of the current serving PLMN, which does not have any disaster condition. The proposed solution allows networks to control access to disaster roaming UEs based on certain threshold conditions of congestion due to disaster roaming support.

In one embodiment, during disaster roaming when one PLMN encounters a disaster condition, other PLMNs can provide services to users of the affected PLMN. UEs from the disaster condition PLMN can register on other PLMNs providing disaster services, and these PLMNs will have a revenue benefit. Sometimes, roaming networks may keep devices attached even though the disaster condition on the home network has ended. In such cases, the PLMN operator of the disaster condition loses revenue, and users cannot get complete services from a roaming PLMN, accessing only a limited set of services. The proposed solution discusses ways for UEs to detect the end of the disaster condition on HPLMN and return faster to HPLMN or EHPLMN or first initial PLMN or VPLMN or reselect to a different disaster services providing PLMN during congestion in the first PLMN.

Existing mechanisms do not specify how networks can control and restrict signaling/registration connections from UEs of other PLMNs trying to connect during a disaster condition while still allowing UEs belonging to their own network. When networks are overloaded, they apply congestion control methods that do not differentiate home network UEs from roaming network UEs, affecting services for home network UEs of the PLMN providing disaster services.

In one embodiment, the solution proposes a control access mechanism to be implemented at the network side to differentiate between normal home users and disaster roaming users.

In one embodiment, the proposed solution benefits networks by controlling congestion from a storm of signaling from disaster roaming UEs. From the UE perspective, the UE can return quicker to home networks from the disaster roaming network and restore full services.

In one embodiment, once a user with the proposed solution and a user without the proposed solution have moved to another network from the home network during a disaster condition, the UE with the proposed solution restores full services quickly compared to the UE without the proposed solution. Providing information on disaster roaming bar enhances the service of the HPLMN UE.

In one embodiment, UE A belongs to PLMN A and is under 5G service, while PLMN B is of a same or different operator or RAT and does not have any service level agreements to support UEs belonging to another operator. However, during a disaster condition, as per local government needs, PLMN B may need to support users from PLMN A trying to register with PLMN B. During a disaster condition, UEs from PLMN A can try to register on PLMN B, creating a lot of signaling and overloading the system. Prior art does not specify how networks can control and restrict signaling connections from UEs of other PLMNs while still allowing UEs belonging to their own network. Existing methods do not differentiate home network UEs from roaming network UEs, affecting services for home network UEs of the PLMN providing disaster services.

No mechanism exists in prior art to restrict specifically the UEs accessing the network due to a disaster condition from a different PLMN or RAT in EPS. The proposed solution addresses network congestion due to disaster roaming and identifies the end of the disaster condition on the home PLMN, allowing UEs to quickly move back to the home PLMN from a non-home PLMN. The proposed solution defines a methodology for controlling UE access to the network during a disaster condition, avoiding network congestion. The network broadcasts access barring information for disaster roaming UEs. UEs access disaster roaming information to identify the end of the disaster condition on the home PLMN and move back to the home PLMN quickly. Without this solution, UEs of the home PLMN face deprived services from their own network while non-home PLMN users receive services. Better handling at the network side for congestion due to disaster roaming and UEs moving to HPLMN faster from the disaster roaming PLMN is achieved.

According to an embodiment, a method performed by a user equipment (UE) for access barring during disaster roaming in a communication network system, may comprise receiving an access stratum (AS) message from a network apparatus providing disaster roaming services for registered UEs, wherein the AS message comprises at least one of disaster-related information or an access barring indication to be applied to inbound disaster roaming UEs, determining whether the UE is barred from using the disaster roaming services from the network apparatus based on the received AS message, in accordance with a determination that the UE is barred from using the disaster roaming services from the network apparatus, preventing to attempt to transmit any non-access stratum (NAS) or the AS message on the network apparatus providing the disaster roaming services, and in accordance with a determination that the UE is not barred from using the disaster roaming services from the network apparatus, allowing to attempt to transmit any NAS or the AS message on the network apparatus.

For example, the method may comprise, in response to determining that the UE is barred from using disaster roaming services, performing, by the UE, at least one of inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN, or preventing that is already registered for the disaster roaming services, from attempting to access the disaster roaming PLMN for mobile originated (MO) signaling or MO data, including for the disaster roaming services, based on the access barring indication.

For example, the method may comprise performing a public land mobile network (PLMN) search to identify and register to another PLMN.

For example, the network apparatus may comprise visited PLMN (VPLMN) providing disaster roaming services on an evolved packet system (EPS).

For example, the access barring indication may include information related to access barring for disaster roaming services as sent by the network apparatus.

For example, the AS message may be received by the UE on the network apparatus in response to a disaster event in a network coverage area of the UE.

For example, the AS message may include at least one of a signaling message or system information block information.

For example, the UE may be configured to determine access barring based on a public land mobile network (PLMN) identification (ID), a cell ID, a tracking area identity (TAI), or radio access technology (RAT) information included in the AS message.

For example, determining whether the UE is barred from using the disaster roaming services may comprise performing a barring check for disaster roaming by a radio resource control (RRC) layer of the UE based on the access barring information received from the network apparatus and a notification from a NAS layer to an AS layer, wherein the notification indicates an establishment cause indicating disaster roaming or a call type indicating disaster roaming.

For example, a user equipment (UE) for access barring during disaster roaming in a communication network system, may comprise communication circuitry, memory, comprising one or more storage media, storing instructions, and one or more processors communicatively coupled to the memory. The instructions, when executed by the one or more processors individually or collectively, may cause the UE to receive an access stratum (AS) message from a network apparatus providing disaster roaming services for registered UEs, wherein the AS message comprises at least one of disaster-related information or an access barring indication to be applied to inbound disaster roaming UEs, determine whether the UE is barred from using the disaster roaming services from the network apparatus based on the received AS message, in accordance with a determination that the UE is barred from using the disaster roaming services from the network apparatus, prevent to attempt to transmit any non-access stratum (NAS) or the AS message on the network apparatus providing the disaster roaming services, and in accordance with a determination that the UE is not barred from using the disaster roaming services from the network apparatus, allow to attempt to transmit any NAS or the AS message on the network apparatus.

For example, the instructions, when executed by the one or more processors individually or collectively, may cause the UE to, in response to determining that the UE is barred from using disaster roaming services, perform at least one of inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN, or preventing that is already registered for the disaster roaming services, from attempting to access the disaster roaming PLMN for mobile originated (MO) signaling or MO data, including for the disaster roaming services, based on the access barring indication.

For example, the instructions, when executed by the one or more processors individually or collectively, may cause the UE to perform a public land mobile network (PLMN) search to identify and register to another PLMN.

For example, the network apparatus may comprise visited PLMN (VPLMN) providing disaster roaming services on an evolved packet system (EPS).

For example, the access barring indication may include information related to access barring for disaster roaming services as sent by the network apparatus.

For example, the AS message may be received by the UE on the network apparatus in response to a disaster event in a network coverage area of the UE.

For example, the AS message may include at least one of a signaling message or system information block information.

For example, the UE may be configured to determine access barring based on a public land mobile network (PLMN) identification (ID), a cell ID, a tracking area identity (TAI), or radio access technology (RAT) information included in the AS message.

For example, the instructions, when executed by the one or more processors individually or collectively, may cause the UE to perform a barring check for disaster roaming by a radio resource control (RRC) layer of the UE based on the access barring information received from the network apparatus and a notification from a NAS layer to an AS layer. The notification may indicate an establishment cause indicating disaster roaming or a call type indicating disaster roaming.

According to an embodiment, a method performed by a network apparatus for access barring during disaster roaming in a communication network system, may comprise creating an access stratum (AS) message comprising disaster-related information and an access barring indication to be applied to inbound disaster roaming user equipment (UE), wherein the network apparatus is providing disaster roaming services to the UE, and transmitting the AS message to the UE during the disaster.

According to an embodiment, one or more non-transitory computer-readable storage media may store one or more computer programs. The one or more computer programs may include computer-executable instructions that, when executed by one or more processors of a user equipment (UE) individually or collectively, may cause the UE to perform operations. The operations may comprise receiving an access stratum (AS) message from a network apparatus providing disaster roaming services for registered UEs, wherein the AS message comprises at least one of disaster-related information or an access barring indication to be applied to inbound disaster roaming UEs, determining whether the UE is barred from using the disaster roaming services from the network apparatus based on the received AS message, in accordance with a determination that the UE is barred from using the disaster roaming services from the network apparatus, preventing to attempt to transmit any non-access stratum (NAS) or the AS message on the network apparatus providing the disaster roaming services, and in accordance with a determination that the UE is not barred from using the disaster roaming services from the network apparatus, allowing to attempt to transmit any NAS or the AS message on the network apparatus.

According to an embodiment, a method performed by a user equipment (UE) for access barring during disaster roaming in a communication network system, may comprise receiving, by the UE, an access stratum (AS) message from a network apparatus providing disaster roaming services for registered UEs, wherein the AS message comprises at least one of disaster-related information or an access barring indication to be applied to inbound disaster roaming UEs, determining, by the UE, whether the UE is barred from using the disaster roaming services from the network apparatus based on the received AS message, and performing, by the UE, one of preventing, by the UE, to attempt to register or send any non-access stratum (NAS) or the AS message on the network apparatus providing the disaster roaming services for registering or sending the NAS or AS signaling message for disaster roaming services, in response to determining that the UE is barred from using the disaster roaming services from the network apparatus, or allowing, by the UE, to attempt to register or send any NAS or the AS message on the network apparatus providing the disaster roaming services for registering or sending the NAS or AS signaling message for disaster roaming services, in response to determining that the UE is not barred from using the disaster roaming services from the network apparatus.

For example, the method may comprise, in response to determining that the UE is barred from using disaster roaming services, performing, by the UE, at least one of inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN, or preventing, by the UE, that is already registered for the disaster roaming services, from attempting to access the disaster roaming PLMN for mobile originated (MO) signaling or MO data, including for the disaster roaming services, based on the access barring indication.

For example, the method may comprise performing, by the UE, a public land mobile network (PLMN) search to identify and register to another PLMN.

For example, the network apparatus may comprise visited PLMN (VPLMN) providing disaster roaming services on an evolved packet system (EPS).

For example, the access barring indication may include information related to access barring for disaster roaming services as sent by the network apparatus.

For example, the AS message may be received by the UE on the network apparatus in response to a disaster event in a network coverage area of the UE.

For example, the AS message may include at least one of a signaling message or system information block information.

For example, the UE may be configured to determine access barring based on a public land mobile network (PLMN) identification (ID), a cell ID, a tracking area identity (TAI), or radio access technology (RAT) information included in the AS message.

For example, determining, by the UE, whether the UE is barred from using the disaster roaming services may comprise performing a barring check for disaster roaming by a radio resource control (RRC) layer of the UE based on the access barring information received from the network apparatus and a notification from a NAS layer to an AS layer, wherein the notification indicates an establishment cause indicating disaster roaming or a call type indicating disaster roaming.

According to an embodiment, a method performed by a network apparatus for access barring during disaster roaming in a communication network system, may comprise creating, by the network apparatus, an access stratum (AS) message comprising disaster-related information and an access barring indication to be applied to inbound disaster roaming user equipment (UE), wherein the network apparatus is providing disaster roaming services to the UE, and sending, by the network apparatus, the AS message to the UE during the disaster.

For example, the AS message may include at least one of a signaling message or system information block (SIB) information.

For example, the access barring indication may include information related to access barring for disaster roaming services as sent by the network apparatus.

For example, the network apparatus may comprise a visited public land mobile network (VPLMN) providing disaster roaming services on an evolved packet system (EPS).

For example, the access barring indication may be provided in the same AS message containing disaster-related information or in a separate system information block (SIB) message from the one containing disaster-related information.

According to an embodiment, a method performed by a user equipment (UE) for access barring during disaster roaming in a communication network system, may comprise receiving, by the UE, a system information block (SIB) information broadcasted by a network apparatus, determining, by the UE, whether a home public land mobile network (HPLMN) or an equivalent HPLMN (EHPLMN) or first initial PLMN or visited public land mobile network (VPLMN) is not part of a list of common PLMNs with disaster conditions, determining, by the UE, that a disaster condition in the HPLMN or EHPLMN or first initial PLMN or VPLMN has ended, when the HPLMN or the EHPLMN or first initial PLMN or VPLMN is not part of the list of common PLMNs with disaster conditions, and deregistering, by the UE, from a current serving network apparatus upon determining that the disaster condition has ended on the HPLMN or the EHPLMN or first initial PLMN or VPLMN.

For example, the method may comprise returning, by the UE, to the HPLMN or EHPLMN or first initial PLMN or VPLMN, and adding, by the UE, the current serving network apparatus to a forbidden PLMN list to prevent immediate re-access to the current serving network apparatus.

For example, only a set of UEs registered with a disaster roaming PLMN for disaster roaming services receive a detach or deregistration request may comprise identifying, by the UE, the HPLMN or the EHPLMN or first initial PLMN or VPLMN is not part of a list of common PLMNs with disaster conditions, and performing, by the UE, a PLMN search and identify availability of the HPLMN or the EHPLMN or any allowed available PLMN and registering on the PLMN by sending a NAS message such as attach request or tracking area update request or service request.

According to an embodiment, a method performed by a user equipment (UE) for access barring during disaster roaming in a communication network system, may comprise registering, by the UE, with a home public land mobile network (HPLMN) or an equivalent home PLMN (EHPLMN) or first initial PLMN or VPLMN for normal services, detecting, by the UE, a disaster condition on the HPLMN or the EHPLMN or first initial PLMN or VPLMN, registering, by the UE, with a network apparatus in response to the detected disaster condition, wherein the network apparatus is initially part of a forbidden PLMN list for the UE, receiving, by the UE, a reject message due to core network congestion with a reject cause code from the network apparatus, performing, by the UE, a PLMN search to find a third PLMN providing disaster roaming services, wherein the third PLMN is different from both the HPLMN or first initial PLMN or VPLMN and a current serving network apparatus, and registering, by the UE, with the third PLMN to maintain or access the disaster roaming services.

For example, the UE may be connected to the network apparatus during disaster roaming.

For example, the reject cause code may be cause #22 indicating congestion.

For example, the UE may be able to access the third PLMN upon successful registration to continue receiving disaster roaming services.

For example, the network apparatus may be operated by a different network operator than the HPLMN. The third PLMN may be operated by a different network operator than the current serving network apparatus to the UE.

According to an embodiment, a user equipment (UE) for access barring during disaster roaming in a communication network system, may comprise memory, comprising one or more storage media, storing instructions, and one or more processors communicatively coupled to the memory. The instructions, when executed by the one or more processors individually or collectively, may cause the UE to receive an access stratum (AS) message from a network apparatus providing disaster roaming services for registered UEs. The AS message may comprise at least one of disaster-related information or an access barring indication to be applied to inbound disaster roaming UEs, determine whether the UE is barred from using disaster roaming services from the network apparatus based on the received AS message, and perform one of prevent to attempt to register or send any non-access stratum (NAS) or the AS message on the network apparatus providing the disaster roaming services for registering or sending the NAS or the AS message for disaster roaming services, in response to determining that the UE is barred from using the disaster roaming services from network apparatus, or allow to attempt to register or send any NAS or the AS message on the network apparatus for registering or sending the NAS or the AS message for disaster roaming services, in response to determining that the UE is not barred from using the disaster roaming services from the network apparatus.

For example, the instructions, when executed by the one or more processors individually or collectively, may cause the UE to, in response to determining that the UE is barred from using disaster roaming services, perform at least one of inhibit based on the access barring indication the UE from initiating non-access stratum (NAS) or AS signaling messages on at least one of the network apparatus, tracking area identity (TAI) associated with a disaster roaming public land mobile network (PLMN), PLMN identification (ID) associated with the disaster roaming PLMN, and a radio access technology (RAT) associated with the disaster roaming PLMN, or prevent that is already registered for the disaster roaming services, from attempting to access the disaster roaming PLMN for mobile originated (MO) signaling or MO data, including for the disaster roaming services, based on the access barring indication.

For example, the instructions, when executed by the one or more processors individually or collectively, may cause the UE to perform a public land mobile network (PLMN) search to identify and register to another PLMN.

For example, the instructions, when executed by the one or more processors individually or collectively, may cause the UE to determine access barring based on a public land mobile network (PLMN) identification (ID), a cell ID, a tracking area identity TAI, or radio access technology (RAT) information included in the AS message.

For example, to determine whether the UE is barred from using the disaster roaming services, the instructions, when executed by the one or more processors individually or collectively, may cause the UE to perform a barring check for disaster roaming by a radio resource control (RRC) layer of the UE based on access barring information received from the network apparatus and a notification from a NAS layer to an AS layer, wherein the notification indicates an establishment cause indicating disaster roaming or a call type indicating disaster roaming.

For example, the instructions, when executed by the one or more processors individually or collectively, may cause the UE to receive a system information block (SIB) information broadcasted by a network apparatus, determine whether a home public land mobile network (PLMN) (HPLMN) or an equivalent home PLMN (EHPLMN) or first initial PLMN or VPLMN is not part of a list of common PLMNs with disaster conditions, determine that a disaster condition in the HPLMN or EHPLMN has ended, when the HPLMN or the EHPLMN or first initial PLMN or VPLMN is not part of the list of common PLMNs with disaster conditions, and deregister from a current serving network apparatus upon determining that the disaster condition has ended on the HPLMN or the EHPLMN or the first initial PLMN or the VPLMN.

For example, the instructions, when executed by the one or more processors individually or collectively, may cause the UE to return to the HPLMN or EHPLMN or first initial PLMN or VPLMN, and add the current serving network apparatus to a forbidden PLMN list to prevent immediate re-access to the network apparatus.

For example, when only a set of the registered UEs with a disaster roaming PLMN for disaster roaming services receive a detach or deregistration request, the instructions, when executed by the one or more processors individually or collectively, may cause the UE to identify the HPLMN or the EHPLMN or first initial PLMN or VPLMN is not part of a list of common PLMNs with disaster conditions, and perform a PLMN search and identifies availability of HPLMN or the EHPLMN or any allowed available PLMN and registering on the PLMN by sending a NAS message such as attach request or tracking area update request or service request.

For example, the instructions, when executed by the one or more processors individually or collectively, may cause the UE to register with a home public land mobile network (HPLMN) or an equivalent home PLMN (EHPLMN) or first initial PLMN or VPLMN for normal services, detect a disaster condition on the HPLMN or the EHPLMN or first initial PLMN or VPLMN, register with a network apparatus in response to the detected disaster condition, wherein the network apparatus is initially part of a forbidden PLMN list for the UE, receive a reject message due to core network congestion with a cause code from the network apparatus, perform a PLMN search to find a third PLMN providing the disaster roaming services. The third PLMN may be different from both the HPLMN and a current serving network apparatus, and register with the third PLMN to maintain or access the disaster roaming services.

For example, the UE may be communicatively connected to a VPLMN providing disaster roaming services on EPS during disaster roaming.

For example, the instructions, when executed by the one or more processors individually or collectively, may cause the UE to access the third PLMN upon successful registration to continue receiving disaster roaming services.

For example, the instructions, when executed by the one or more processors individually or collectively, may cause the UE to receive a system information block (SIB) information broadcasted by the network apparatus, determine that the disaster condition has ended upon identifying that a home public land mobile network (PLMN) (HPLMN) or an equivalent home PLMN (EHPLMN) or first initial PLMN or VPLMN is not part of a list of common PLMNs with disaster conditions is not part of the common PLMNs with disaster condition list in the SIB, and deregister from the third PLMN.

For example, the instructions, when executed by the one or more processors individually or collectively, may cause the UE to register on the HPLMN or the EHPLMN or the first initial PLMN or the VPLMN based on the SIB information after deregistering from the third PLMN.

According to an embodiment, a network apparatus for access barring during disaster roaming in a communication network system, may comprise memory, comprising one or more storage media, storing instructions, and one or more processors communicatively coupled to the memory. The instructions, when executed by the one or more processors individually or collectively, may cause the network apparatus to create an access stratum (AS) message comprising disaster-related information and an access barring indication to be applied to inbound disaster roaming user equipment (UE), wherein the network apparatus is providing disaster roaming services to the UE, and send the AS message to the UE during the disaster.

According to an embodiment, one or more non-transitory computer-readable storage media may store one or more computer programs. The one or more computer programs may include computer-executable instructions that, when executed by one or more processors of a user equipment (UE) individually or collectively, cause the UE to perform operations. The operations may comprise receiving, by the UE, an access stratum (AS) message from a network apparatus providing disaster roaming services for registered UEs, wherein the AS message comprises at least one of disaster-related information or an access barring indication to be applied to inbound disaster roaming UEs, determining, by the UE, whether the UE is barred from using the disaster roaming services from the network apparatus based on the received AS message, and performing, by the UE, one of preventing, by the UE, to attempt to register or send any non-access stratum (NAS) or the AS message on the network apparatus providing the disaster roaming services for registering or sending the NAS or AS signaling message for disaster roaming services, in response to determining that the UE is barred from using the disaster roaming services from the network apparatus, or allowing, by the UE, to attempt to register or send any NAS or the AS message on the network apparatus providing the disaster roaming services for registering or sending the NAS or AS signaling message for disaster roaming services, in response to determining that the UE is not barred from using the disaster roaming services from the network apparatus.

For example, the operations may comprise performing at least one of inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN, or preventing, by the UE, that is already registered for the disaster roaming services, from attempting to access the disaster roaming PLMN for mobile originated (MO) signaling or MO data, including for the disaster roaming services, based on the access barring indication.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. In one embodiment of the disclosure, the electronic devices are not limited to those described above.

It should be appreciated that one or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, in one embodiment, the module may be implemented in a form of an Application-Specific Integrated Circuit (ASIC).

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In one embodiment, an operational procedure according to one or more embodiments of the disclosure may be included and provided in a computer program product. The computer program product may be traded as a product between a seller and a buyer. The computer program product may be distributed in the form of a machine-readable storage medium (e.g., Compact Disc Read Only Memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method performed by a user equipment (UE) for access barring during disaster roaming in a communication network system, the method comprising:
receiving an access stratum (AS) message from a network apparatus providing disaster roaming services for registered UEs, wherein the AS message comprises at least one of disaster-related information or an access barring indication to be applied to inbound disaster roaming UEs;
determining whether the UE is barred from using the disaster roaming services from the network apparatus based on the received AS message;
in accordance with a determination that the UE is barred from using the disaster roaming services from the network apparatus, preventing to attempt to transmit any non-access stratum (NAS) or the AS message on the network apparatus providing the disaster roaming services; and
in accordance with a determination that the UE is not barred from using the disaster roaming services from the network apparatus, allowing to attempt to transmit any NAS or the AS message on the network apparatus.

2. The method of claim 1, further comprising:
in response to determining that the UE is barred from using disaster roaming services, performing, by the UE, at least one of:
inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN; or
preventing that is already registered for the disaster roaming services, from attempting to access the disaster roaming PLMN for mobile originated (MO) signaling or MO data, including for the disaster roaming services, based on the access barring indication.

3. The method of claim 1, further comprising:
performing a public land mobile network (PLMN) search to identify and register to another PLMN.

4. The method of claim 1, wherein the network apparatus comprises visited PLMN (VPLMN) providing disaster roaming services on an evolved packet system (EPS).

5. The method of claim 1, wherein the access barring indication includes information related to access barring for disaster roaming services as sent by the network apparatus.

6. The method of claim 1, wherein the AS message is received by the UE on the network apparatus in response to a disaster event in a network coverage area of the UE.

7. The method of claim 1, wherein the AS message includes at least one of a signaling message or system information block information.

8. The method of claim 1, wherein the UE is configured to determine access barring based on a public land mobile network (PLMN) identification (ID), a cell ID, a tracking area identity (TAI), or radio access technology (RAT) information included in the AS message.

9. The method of claim 1, wherein determining whether the UE is barred from using the disaster roaming services comprises:
performing a barring check for disaster roaming by a radio resource control (RRC) layer of the UE based on the access barring information received from the network apparatus and a notification from a NAS layer to an AS layer, wherein the notification indicates an establishment cause indicating disaster roaming or a call type indicating disaster roaming.

10. A User Equipment (UE) for access barring during disaster roaming in a communication network system, the UE comprising:
communication circuitry;
memory, comprising one or more storage media, storing instructions; and
one or more processors communicatively coupled to the memory,
wherein the instructions, when executed by the one or more processors individually or collectively, cause the UE to:
receive an access stratum (AS) message from a network apparatus providing disaster roaming services for registered UEs, wherein the AS message comprises at least one of disaster-related information or an access barring indication to be applied to inbound disaster roaming UEs;
determine whether the UE is barred from using the disaster roaming services from the network apparatus based on the received AS message;
in accordance with a determination that the UE is barred from using the disaster roaming services from the network apparatus, prevent to attempt to transmit any non-access stratum (NAS) or the AS message on the network apparatus providing the disaster roaming services; and
in accordance with a determination that the UE is not barred from using the disaster roaming services from the network apparatus, allow to attempt to transmit any NAS or the AS message on the network apparatus.

11. The UE of claim 10, wherein the instructions, when executed by the one or more processors individually or collectively, cause the UE to:
in response to determining that the UE is barred from using disaster roaming services, perform at least one of:
inhibiting, based on the access barring indication, the UE from initiating NAS signaling messages or AS signaling messages on at least one of the network apparatus, Tracking Area Identity (TAI) associated with a disaster roaming public land mobile network (PLMN), PLMN identification (ID) associated with the PLMN, and a Radio Access Technology (RAT) associated with the disaster roaming PLMN; or
preventing that is already registered for the disaster roaming services, from attempting to access the disaster roaming PLMN for mobile originated (MO) signaling or MO data, including for the disaster roaming services, based on the access barring indication.

12. The UE of claim 10, wherein the instructions, when executed by the one or more processors individually or collectively, cause the UE to:
perform a public land mobile network (PLMN) search to identify and register to another PLMN.

13. The UE of claim 10, wherein the network apparatus comprises visited PLMN (VPLMN) providing disaster roaming services on an evolved packet system (EPS).

14. The UE of claim 10, wherein the access barring indication includes information related to access barring for disaster roaming services as sent by the network apparatus.

15. The UE of claim 10, wherein the AS message is received by the UE on the network apparatus in response to a disaster event in a network coverage area of the UE.

16. The UE of claim 10, wherein the AS message includes at least one of a signaling message or system information block information.

17. The UE of claim 10, wherein the UE is configured to determine access barring based on a public land mobile network (PLMN) identification (ID), a cell ID, a tracking area identity (TAI), or radio access technology (RAT) information included in the AS message.

18. The UE of claim 10, wherein the instructions, when executed by the one or more processors individually or collectively, cause the UE to:
perform a barring check for disaster roaming by a radio resource control (RRC) layer of the UE based on the access barring indication received from the network apparatus and a notification from a NAS layer to an AS layer, wherein the notification indicates an establishment cause indicating disaster roaming or a call type indicating disaster roaming.

19. A method performed by a network apparatus for access barring during disaster roaming in a communication network system, the method comprising:
creating an access stratum (AS) message comprising disaster-related information and an access barring indication to be applied to inbound disaster roaming user equipment (UE), wherein the network apparatus is providing disaster roaming services to the UE; and
transmitting the AS message to the UE during the disaster.

20. One or more non-transitory computer-readable storage media storing one or more computer programs including computer-executable instructions that, when executed by one or more processors of a user equipment (UE) individually or collectively, cause the UE to perform operations, the operations comprising:
receiving an access stratum (AS) message from a network apparatus providing disaster roaming services for registered UEs, wherein the AS message comprises at least one of disaster-related information or an access barring indication to be applied to inbound disaster roaming UEs;
determining whether the UE is barred from using the disaster roaming services from the network apparatus based on the received AS message;
in accordance with a determination that the UE is barred from using the disaster roaming services from the network apparatus, preventing to attempt to transmit any non-access stratum (NAS) or the AS message on the network apparatus providing the disaster roaming services; and
in accordance with a determination that the UE is not barred from using the disaster roaming services from the network apparatus, allowing to attempt to transmit any NAS or the AS message on the network apparatus.
